(19) United States
(12) Patent Application Publication
(10) Pub. No.: US 2023/0401423 A1
(43) Pub. Date: Dec. 14, 2023

(54) GRAPH EMBEDDING SYSTEMS AND APPARATUS

(71) Applicant: BenevolentAI Technology Limited, London (GB)

(72) Inventors: Aaron SIM, London (GB); Maciej Ludwick Wiatrak, London (GB); Angus Richard Greville Brayne, London (GB); Paidi CREED, London (GB); Saee Paliwal, Brooklyn, NY (US)

(73) Assignee: BenevolentAI Technology Limited, London (GB)

(21) Appl. No.: 18/365,325

(22) Filed: Aug. 4, 2023

Related U.S. Application Data
(63) Continuation of application No. PCT/GB2021/051322, filed on May 28, 2021.
(60) Provisional application No. 63/145,899, filed on Feb. 4, 2021.

(51) Int. Cl. G06N 3/04; G06N 3/08

(52) U.S. Cl. CPC G06N 3/04; G06N 3/08

(57) ABSTRACT

Methods and apparatus are provided for generating an embedding of a graph. The graph includes a plurality of nodes and each node includes a connection to another one or more of the nodes. The method including and/or apparatus configured to: receiving data representative of at least a portion of the graph; transforming the nodes of the graph into a non-Euclidean geometry; iteratively updating an embedding model based the transformed nodes in the non-Euclidean geometry based on a causal loss function and a link prediction function associated with the non-Euclidean geometry.

### CROSS-REFERENCE TO RELATED APPLICATIONS

The present application is a bypass continuation of International Application No. PCT/GB2021/051322, filed May 28, 2021, which in turn claims the priority benefit of U.S. Application No. 63/145,899, filed Feb. 4, 2021. Each of these applications is incorporated herein by reference in its entirety for all purposes.

### FIELD OF INVENTION

The present application relates to apparatus, system(s) and method(s) for embedding graphs or graph structures into non-Euclidean spaces and/or applications thereto.

### BACKGROUND

Large scale causal inference based on observational data is increasingly important in machine learning. Traditionally, this inference of relationships between entities relies on a distance-based approach applied to knowledge graph entities embedded in latent Euclidean spaces. Unfortunately, in addition to false positives resulting in mistakenly ascribed direct causal relationships, current methods often fail to account for causality entirely or miss causal relationships due to confounders and intermediaries.

There is a desire to generate improved graph embeddings that overcome the above-mentioned problems for use in link prediction or more improved training of and/or input to machine learning algorithms, models and the like.

The embodiments described below are not limited to implementations which solve any or all of the disadvantages of the known approaches described above.

### SUMMARY

This Summary is provided to introduce a selection of concepts in a simplified form that are further described below in the Detailed Description. This Summary is not intended to identify key features or essential features of the claimed subject matter, nor is it intended to be used to determine the scope of the claimed subject matter; variants and alternative features which facilitate the working of the invention and/or serve to achieve a substantially similar technical effect should be considered as falling into the scope of the invention disclosed herein.

Methods, apparatus and systems are provided for directed link prediction in graphs including knowledge graphs, and/or any directed graph that uses knowledge graph embeddings in non-Euclidean geometries/spaces/manifolds such as, without limitation, for example pseudo-Riemannian manifolds. For example, Minkowski, anti-de Sitter, and/or de Sitter spacetimes and the like may be used. By embedding a knowledge graph within these geometries and/or non-trivial topologies (e.g. cylindrical topologies) and applying a unique loss function or cost function including a link prediction function such as a triple fermi dirac function as described herein, the embedding methods, apparatus, systems enable the algorithm to predict directed edges, connections, or links due to taking advantage of the time-like dimension of the geometry capturing the directionality of any relationships.

In a first aspect, the present disclosure provides a computer-implemented method of generating an embedding of a graph, wherein the graph comprises a plurality of nodes and each node includes a connection to another one or more of the nodes, the method comprising: receiving data representative of at least a portion of the graph; transforming the nodes of the graph into a non-Euclidean geometry; iteratively updating an embedding model based the transformed nodes in the non-Euclidean geometry based on a causal loss function and a link prediction function associated with the non-Euclidean geometry.

Optionally, the computer-implemented method of the first aspect, wherein: transforming the nodes of the graph further comprises transforming the nodes of the graph into coordinates of the non-Euclidean geometry; and wherein the embedding model is based on a non-Euclidean stochastic gradient descent algorithm operating on the node coordinates using the causal loss function.

As an option, the computer-implemented method of the first aspect, wherein updating the embedding model further includes updating the node coordinates by minimising the causal loss function based on at least the embeddings and the link prediction function.

As another option, the computer-implemented method of the first aspect, further comprising iteratively updating the embedding model until the embedding model is determined to be trained; a maximum number of iterations has been reached, and/or or until an average loss threshold has been met for all node coordinates; and outputting data representative of the graph embedding once trained.

As another option, the computer-implemented method of the first aspect, wherein the graph is a directed graph.

As an option, the computer-implemented method of the first aspect, wherein the graph is a cyclic directed graph.

As an option, the computer-implemented method of the first aspect, wherein the graph is an acyclic directed graph.

As another option, the computer-implemented method of the first aspect, wherein the non-Euclidean geometry is a pseudo-Riemannian geometry.

Optionally, the computer-implemented method of the first aspect, wherein the non-Euclidean geometry is a pseudo-Riemannian geometry or space.

As an option, the computer-implemented method of the first aspect, wherein the pseudo-Riemannian geometry or space is a Minkowski geometry or space.

As an option, the computer-implemented method of the first aspect, wherein the pseudo-Riemannian geometry or space is an anti-de Sitter geometry or space.

As an option, the computer-implemented method of the first aspect, wherein the non-Euclidean geometry or space is a hyperbolic geometry or space.

Optionally, the computer-implemented method of the first aspect, wherein the graph is an entity-entity graph comprising a plurality of entity nodes and a plurality of edges/connections/links, wherein each entity node connects to another entity node via an edge/connection/link, each edge/connection/link representing a relationship between said each entity node and the connected said other entity node.

As an option, the computer-implemented method of the first aspect, wherein an entity node in the entity-entity graph represents any entity from the group of: gene; disease; compound/drug; protein; biological entity; pathway; biological process; cell-line; cell-type; symptom; clinical trials; any other biomedical concept; or any other entity with at least an entity-entity relationship to another entity in the entity-entity graph.

As another option, the computer-implemented method of the first aspect, further comprising outputting the embeddings of the graph from the trained entity model for use in downstream process(es) including one or more from the group of: drug discovery; drug optimisation; and/or for any other ML model or training any other ML model for predicting or classifying in a drug discovery or optimisation process.

As an option, the computer-implemented method of the first aspect, further comprising: predicting link relationships between nodes or entity nodes in the embeddings of the graph based on inputting data representative of a first and second node into the link prediction function; and receiving from the link prediction function an indication of the likelihood of a link relationship existing between said first and second node.

In a second aspect, the present disclosure provides a computer-implemented method for link prediction in a graph further comprising: generating a graph embedding according to any of the features of the first aspect; and selecting at least a first and second node coordinate from the graph embedding; outputting a directed link prediction based on inputting the selected first and second node coordinate to the link prediction function, wherein the directed link prediction includes an indication of the likelihood of a link relationship existing between the first and second node coordinates.

In a third aspect, the present disclosure provides a computer-implemented method for predicting a directed relationship between entities in a graph further comprising: generating a graph embedding based on the graph in accordance with any of the features of the first and/or second aspects; and selecting at least a first and second entity node coordinate from the graph embedding, the at least first and second entity node coordinates associated with at least the first and second entity of the graph; outputting a directed relationship prediction based on inputting the selected at least first and second entity node coordinate to the link prediction function, wherein the directed relationship prediction includes an indication of the likelihood of a relationship link existing between the at least first and second entity node coordinates.

As an option, the computer-implemented method of the first, second and/or third aspects, wherein for non-Euclidean spaces with spacetime manifolds, the link prediction function is based on the Fermi-Dirac function.

As an option, the computer-implemented method of the first, second and/or third aspects, wherein the link prediction function is based on a Triple Fermi-Dirac function comprising:

$${ℱ}_{( {τ}_{1} , {τ}_{2} , α , r , k )} ( p , q ) := {k ( {F}_{1} {F}_{2} {F}_{3} )}^{1 / 3} ,$$

where k>0 is a tunable scaling factor and

F₁:=F_{(τ}_{₁}_{,r,1)}(s²),

F₂:=F_{(τ}_{₂}_{,0,1)}(−Δt),

F₃:=F_{(τ}_{₂}_{,0,Δ)}(Δt),
are| three FD distribution terms. s² is the squared geodesic distance between p and q, Δt≡t_{q}−tₚ the difference in the time coordinates, and τ₁ τ₂, r and α the parameters from

$${F}_{( τ , r , α )} ( x ) := \frac{1}{{e}^{( α x - r ) / T} + 1} ,$$

with x∈ [symbol] and parameters τ, r≥0, and 0≤α≤1, is used to represent the probability of undirected graph edges as a function of node embedding distances.

As an option, the computer-implemented method of the first, second and/or third aspects, wherein the causal loss function includes the link prediction function.

As an option, the computer-implemented method of the first, second and/or third aspects, wherein the causal loss function comprises a cross entropy loss function combined with the link prediction function.

As an option, the computer-implemented method of the first, second and/or third aspects, wherein the cross entropy loss function comprises a Multinomial Log Loss function or other Log Loss function using the link prediction function as the probability for the Multinomial Log Loss function or other Log Loss function.

As another option, the computer-implemented method of the first, second and/or third aspects, wherein the causal loss function is used to conduct link predictions from the graph embedding that capture the directionality of relationships between nodes in the graph.

As a further option, the computer-implemented method of the first, second and/or third aspects, further comprising creating a manifold or cylindrical topology by wrapping the non-Euclidean space in one dimension into a circle to create a higher-dimensional cylinder.

As an option, the computer-implemented method of the first, second and/or third aspects, wherein the manifold or cylindrical topology is a Pseudo-Riemannian manifold.

In a fourth aspect, there is provided an apparatus for generating an embedding a graph, wherein the graph comprises a plurality of nodes and each node includes a connection to another one or more of the nodes, the apparatus comprising a processor coupled to a communication interface, wherein: the communication interface is configured to receiving data representative of at least a portion of the graph; the processor is configured to: transform the nodes of the graph into a non-Euclidean geometry; and iteratively updating an embedding model based the transformed nodes in the non-Euclidean geometry based on a causal loss function associated with the non-Euclidean geometry, wherein the causal loss function includes a link prediction function.

As an option, the computer-implemented method of fourth aspect, wherein the communication interface is configured to output the graph embeddings.

As an option, the computer-implemented method of fourth aspect, wherein the apparatus is configured to implement the computer-implemented method according to any preceding claim.

In a fifth aspect, there is provided an embedding model obtained from a computer-implemented method as described in any of the first, second, third, and/or fourth aspects, modifications thereto, combinations thereof; as herein described and/or as the application demands.

In a sixth aspect, there is provided a graph embedding for a graph obtained from a computer-implemented method as described in any of the first, second, third, fourth and/or fifth aspects, modifications thereto, combinations thereof; as herein described and/or as the application demands.

In a seventh aspect, there is provided a ML model obtained from a training dataset based on a graph embedding according to the sixth aspect.

In an eighth aspect, there is provided a ML model obtained from a training dataset based on a graph embedding based on the computer-implemented method as described in any of the first, second, third, fourth and/or fifth aspects, modifications thereto, combinations thereof; as herein described and/or as the application demands.

In a ninth aspect, there is provided a tangible (or non-transitory) computer-readable medium comprising data or instruction code for generating an embedding of a graph, which, when executed on one or more processor(s), causes at least one of the one or more processor(s) to perform at least one of the steps of: receiving data representative of at least a portion of the graph; transform the nodes of the graph into a non-Euclidean geometry; and iteratively updating an embedding model based the transformed nodes in the non-Euclidean geometry based on a causal loss function associated with the non-Euclidean geometry, wherein the causal loss function includes a link prediction function.

In a tenth aspect, there is provided computer-readable medium comprising program data or instruction code which, when executed on a processor, causes the processor to perform one or more steps of the computer-implemented method as described in any of the first, second, third, fourth and/or fifth aspects, modifications thereto, combinations thereof; as herein described and/or as the application demands.

As an option, the nodes of the graph are separated in a pseudo-Riemannian spaces distinctively in relation to space and time parameters.

As an option, the graph is embedded topologically in manifolds.

As an option, the causal loss function or the link prediction function are configured to replace nodes of the graph based on time by varying rate of decay of the functions.

As an option, the causal loss function or the link prediction function are configured to relax transitivity of nodes based on temporal decay of the functions.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features or options may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a schematic diagram illustrating various example Fermi-Dirac functions for use with the embedding model according to the invention;

FIG. 2 is a schematic diagram illustrating an example of: A) a Tri-partite graph, B) Euclidean embeddings of the Tripartite graph; and C) a Minkowski embedding of the Tripartite graph based on the embedding model according to the invention;

FIG. 3 is a schematic diagram illustrating an example performance of an embedding model for a Minkowski embedding according to the invention;

FIG. 4A is a schematic illustration of an example a 5-node chain used as training data for the embedding model according to the invention;

FIG. 4B is a schematic illustration of an example embedding model using a 2-D Minkowski embeddings on the training data of FIG. 4A;

FIG. 4C is a schematic illustration of an example embedding model using a cylindrical Minkowski embeddings on the training data of FIG. 4A;

FIG. 4D is a schematic illustration of an example embedding model using a cylindrical anti de-Sitter embeddings on the training data of FIG. 4A;

FIG. 4E is a schematic diagram illustrating an example of edge probabilities for 5-node cycle using Minkowski embeddings of FIG. 4B, cylindrical Minkowski embeddings of FIG. 4C and Anti-de Sitter (AdS) embeddings of FIG. 4D according to the invention;

FIG. 5 is a graph diagram illustrating an example average precision values on link prediction according to the invention;

FIG. 6 is a flow diagram illustrating an example process for embedding a graph according to the invention;

FIG. 7a is a schematic diagram of a computing system according to the invention; and

FIG. 7b is a schematic diagram of a system according to the invention.

FIG. 8 is a schematic illustration of further examples of training data in relation to FIG. 4A to 4E.

Common reference numerals are used throughout the figures to indicate similar features.

### DETAILED DESCRIPTION

Embodiments of the present invention are described below by way of example only. These examples represent the best mode of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

The invention relates to a system, apparatus and method(s) for efficiently generating and training a robust embedding model for embedding nodes of graphs or graph structures in a non-Euclidean space for improving link prediction and in particular for use in directed link prediction and the like, and/or for outputting the embeddings of the graph or graph structure as features for input and/or use by downstream process(es) such as, without limitation, for example training one or more models and/or ML algorithms for drug design and/or optimisation and the like; and/or input to one or more models and/or ML algorithms trained for drug design and/or optimisation and the like.

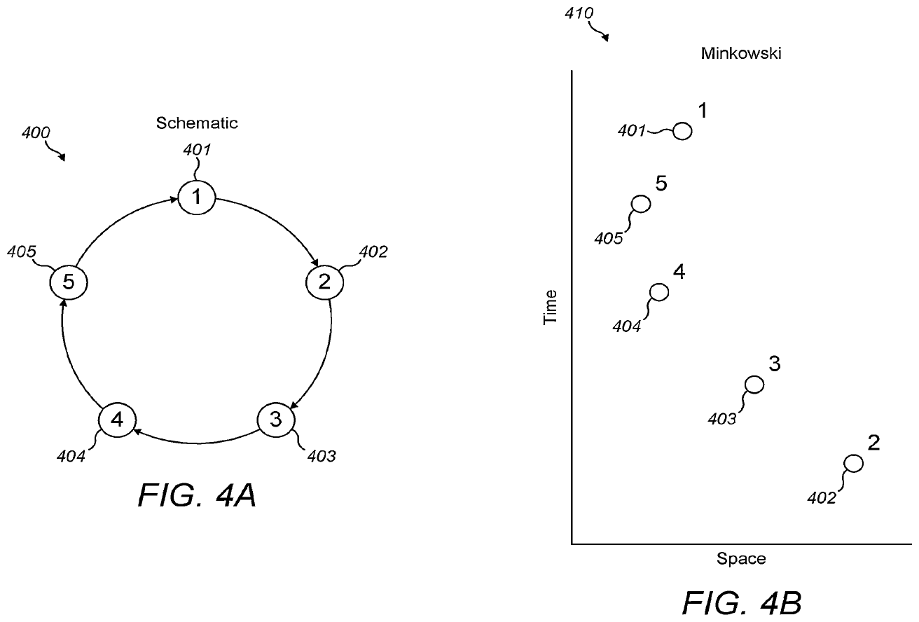

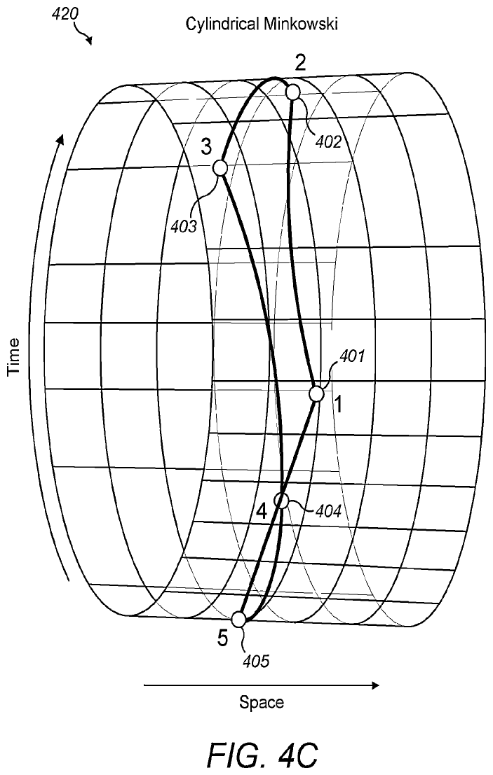

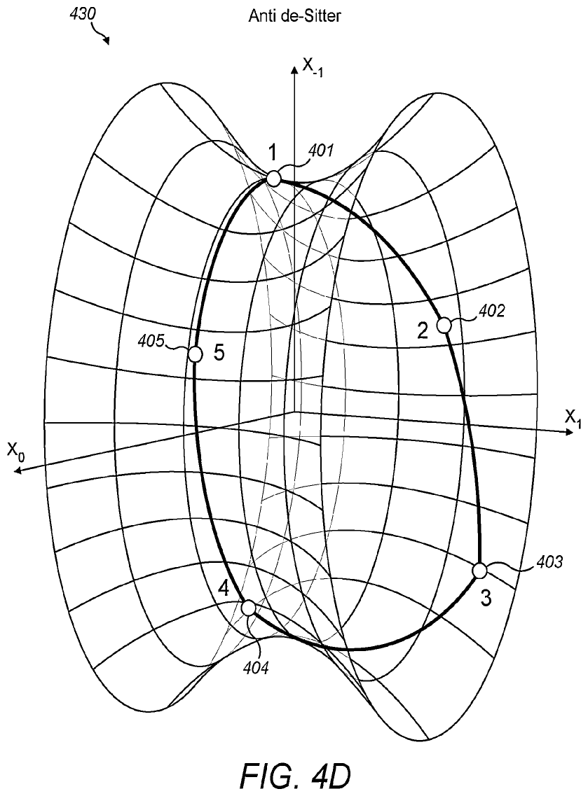

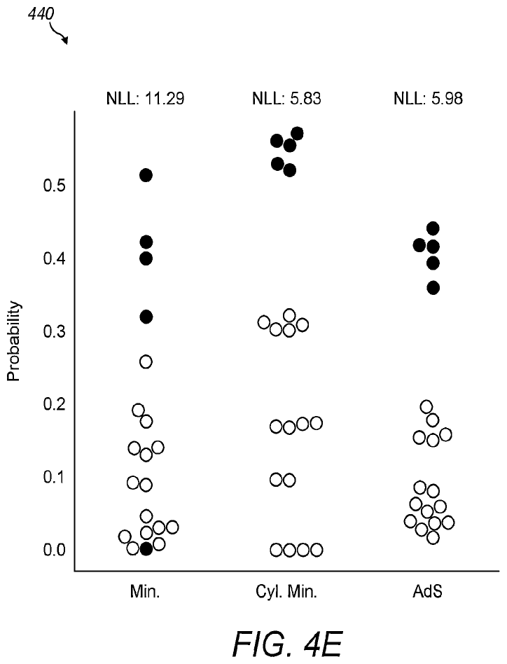

In terms of training, it is understood that various groups of experiments are performed using data such as 5-node chain, see FIG. 4A. Using small synthetic graphs, a demonstration of the invention's ability to encode the particular set of graph-specific features relevant to the Pseudo-Riemannian embedding models. Specifically, the graph-specific features include but are not limited to cycles and non-transitive relations of the graph. For first group of experiments, the model is ran on a series of benchmarks and an ablation study to characterise the utility of herein described embeddings in downstream applications. For second group of experiments, following three classes of directed graph datasets are relied on.

Duplication Divergence Model: A two-parameter model that simulates the growth and evolution of large protein-protein interaction networks Ispolatov et al. (2005). Depending on the topology of the initial seed graphs, the final graph is either a DAG or a directed graph with cycles. Here we simulate both.
DREAM5: Gold standard edges from a genome-scale network inference challenge, comprising a set of gene regulatory networks across organisms and an in silico example Marbach et al. (2012). These networks contain a relatively small number of cycles.
WordNet: An acyclic, hierarchical, tree-like network of nouns, each with relatively few ancestors and many descendants. We consider networks with different proportions of transitive closure. WordNet dataset is used in relation to an example of DAG.

From these groups of experiments, it is sought to minimize the negative log-likelihood loss based on the probabilities in regards to equations (14) or (15) presented in the following sections. Negative sampling ratio of 4 throughout is fixed for example. Similar to Nickel & Kiela (2017), we initialise our embeddings in a small random patch near the origin (x=(1, 0, . . . , 0) for AdS) and perform a burn-in phase of several epochs with the learning rate scaled by a factor of 0.01.

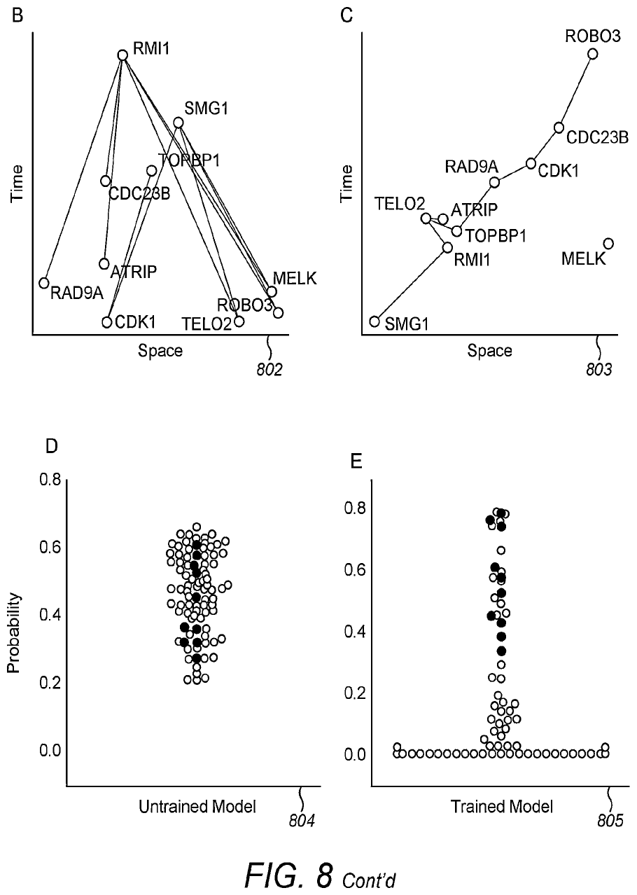

Additional examples of the data used for training are described throughout this application and by the figures. At least one example is shown on FIG. 8.

The non-Euclidean space is an N-=dimensional non-Euclidean space (e.g. N>=2) including, but not limited to, a pseudo-Riemannian geometry; a pseudo-Riemannian geometry or space; a Minkowski geometry or space; an anti-de Sitter geometry or space; an de-Sitter geometry or space; an hyperbolic geometry or space; any other suitable geometry, suitable non-Euclidean geometry, and/or spacetime geometry/space; combinations thereof, modifications thereof and/or as herein described. The graph or graph structure may be based on an entity-entity graph structure with two or more nodes connected by one or more edges, connections, or links, each node representing an entity and each edge/connection/link representing a relationship between an entity and another entity.

The inductive biases of graph representation learning algorithms are often encoded in the background geometry of their embedding space. In this disclosure it is shown that general directed graphs can be effectively represented by an embedding model that combines, without limitation, for example three components: a pseudo-Riemannian metric structure, a non-trivial global topology, and a unique likelihood function that explicitly incorporates a preferred direction in embedding space.

The representational capabilities of this method are demonstrated by applying it to the task of link prediction on a series of synthetic and real directed graphs from natural language applications and biology (e.g. bioinformatics/chem(o)informations). In particular, it is shown that low-dimensional cylindrical Minkowski and anti-de Sitter spacetimes can produce equal or better graph representations than curved Riemannian manifolds of higher dimensions.

The graph structure may be a knowledge graph comprising a plurality of nodes and each of the nodes connected by an edge to another of the plurality of nodes, where a node represents a feature or entity and an edge includes data representative of a relationship between pairs of nodes. The edge may be connection or linkage between two nodes. For example, the graph structure may be based on, without limitation, an entity-entity graph represented by a plurality of entity nodes in which each entity node is connected to one or more entity nodes of the plurality of entity nodes by one or more corresponding relationship edges, in which each relationship edge represents a relationship between a pair of entities. A directed graph is one in which each edge from a node to another node has a particular direction, in which the edge represents the directed relationship from the node to another node. The term graph, directed graph, entity-entity graph, entity-entity knowledge graph, graph, or graph dataset may be used interchangeably throughout this disclosure. In examples of the invention, the graph is a directed cyclic or acyclic graph or knowledge graph and the like.

An entity may comprise or represent any portion of information or a fact that has a relationship with another portion of information or another fact. For example, in the biological, chem(o)informatics or bioinformatics space(s) an entity may comprise or represent a biological entity such as, by way of example only but is not limited to, a disease, gene, protein, compound, chemical, drug, biological pathway, biological process, anatomical region or entity, tissue, cell-line, or cell type, or any other biological or biomedical entity and the like. In another example, entities may comprise a set of patents, literature, citations or a set of clinical trials that are related to a disease or a class of diseases.

In another example, in the data informatics fields and the like, an entity may comprise or represent an entity associated with, by way of example but not limited to, news, entertainment, sports, games, family members, social networks and/or groups, emails, transport networks, the Internet, Wikipedia pages, documents in a library, published patents, databases of facts and/or information, and/or any other information or portions of information or facts that may be related to other information or portions of information or facts and the like. Entities and relationships may be extracted from a corpus of information such as, by way of example but is not limited to, a corpus of text, literature, documents, web-pages; distributed sources such as the Internet; a database of facts and/or relationships; and/or expert knowledge base systems and the like; or any other system storing or capable of retrieving portions of information or facts (e.g. entities) that may be related to (e.g. relationships) other information or portions of information or facts (e.g. other entities) and the like.

For example, in the biological, chem(o)informatics or bioinformatics space(s), an entity-entity graph may be formed from a plurality of entities in which each entity may represent a biological entity from the group of: from the disease, gene, protein, compound, chemical, drug, biological pathway, biological process, anatomical region or entity, tissue, cell-line, or cell type, clinical trials, any other biological or biomedical entity and the like. Each of the plurality of entities may have a relationship with another one or more entities of the plurality of entities. Thus, an entity-entity graph may be formed with entity nodes including data representative of the entities and relationship edges/connections/links connecting entities including data representative of the relations/relationships between the entities. The entity-entity graph may include a mixture of different entities with relationships therebetween, and/or may include a homogenous set of entities with relationships therebetween.

Although details of the present disclosure may be described, by way of example only but is not limited to, with respect to biological, chem(o)informatics or bioinformatics entities, entity-entity graphs and the like it is to be appreciated by the skilled person that the details of the present disclosure are applicable as the application demands to any other type of entity, information, data informatics fields and the like.

Representation learning of symbolic objects is a central area of focus in machine learning. Alongside the design of deep learning architectures and general learning algorithms, incorporating the right level of inductive biases is key to efficiently building faithful and generalisable entity and relational embeddings Battaglia et. al. (2018).

In graph representation learning, the embedding space geometry itself encodes many such inductive biases, even in the simplest of spaces. For instance, vertices embedded as points in Euclidean manifolds, with inter-node distance guiding graph traversal and link prediction Grover & Leskovec (2016), Perozzi et al. (2014), carry the underlying assumptions of homophily and node similarity as a metric function.

The growing recognition that Euclidean geometry lacks the flexibility to encode complex relationships on large graphs at tractable ranks, without loss of information Nickel et al. (2011); Bouchard et al. (2015), has spawned numerous embedding models with non-Euclidean geometries. Examples range from complex manifolds for simultaneously encoding symmetric and anti-symmetric relations Trouillon et al. (2016), to statistical manifolds for representing uncertainty Vilnis & McCallum (2015).

One key development was the introduction of hyperbolic embeddings for hierarchical representation learning Nickel & Kiela (2017, 2018), which demonstrated the ability to uncover latent graph features. In light of its limitations Sala et al. (2018), this approach was subsequently extended to cover directed acyclic graph (DAG) structures in methods like Order-Embeddings Vendrov et al. (2016), Hyperbolic Entailment Cones Ganea et al. (2018) and Hyperbolic Disk embeddings Suzuki et al. (2019), the latter achieving good performances on complex DAGs with exponentially growing numbers of ancestors and descendants.

While these methods continue to capture more complex graph topologies, they are largely limited to DAGs with transitive relations, thus failing to represent many naturally occurring graphs, where cycles and non-transitive relations are common features.

The method of embedding a graph in a non-Euclidean space may be used to address these issues. To directly address these issues, in this disclosure, non-Euclidean geometries such as, without limitation, for example pseudo-Riemannian embeddings of both DAGs and graphs with cycles, specifically considering embeddings in, without limitation, for example Minkowski and anti-de Sitter spacetimes, and the like and/or as the application demands. By constructing a novel likelihood function of both the squared geodesic distance and the time interval, meaningful graph structures may be learnt, such as directed cycles. This approach affords the additional ability to disambiguate semantic similarity and direct edge, connection, linkage connectivity leading to, without limitation, for example improved graph embeddings as feature inputs to downstream process(es).

Some of the advantages and/or features of the method of embedding a graph in a non-Euclidean space includes, without limitation, for example:
The distinction of space- and timelike separation of nodes (or entity nodes) in pseudo-Riemannian spaces allows the model to disentangle semantic and edge-based similarities;
Embeddings of a graph in topologically non-trivial manifolds are able to capture complex graph structural information such as directed cycles, that previous embedding methods fail to effectively represent;
The ability to vary the rate of decay in the future and past time-like dimension of our loss function allows us to simultaneously represent directed relations and flexibly violate the transitivity condition of partial ordering. By placing a node far in the future, transitivity is not guaranteed, which is a novel feature of the present approach.

The aforementioned features of the method of embedding graphs in non-Euclidean spaces is illustrated based on, for simplicity and by way of example only but the invention is not so limited, a series of small, simulated toy networks. Using these, it is demonstrated that the quality of pseudo-Riemannian embeddings over Euclidean and hyperbolic embeddings in experiments using both synthetic protein-protein interaction (PPI) networks and the DREAM5 gold standard graphs, which emulate the structure of causal gene regulatory networks. Additionally, it is shown that the method of embedding graphs in non-Euclidean spaces has comparable performance to DAG-specific methods such as Disk Embeddings on the WordNet link prediction benchmark. Finally, the ability of anti-de Sitter embeddings is explored to further capture unique graph structures by exploiting critical features of the manifold, such as its intrinsic S¹× [symbol] ^{N} topology for representing directed cycles of different lengths.

In related work, the disadvantages of Euclidean geometry compared to non-Euclidean gometries such as, without limitation, for example Minkowski spacetime for graph representation learning was first highlighted in Sun et al. (2015). It was followed by Clough & Evans (2017) who explore DAG representations in Minkowski space, borrowing ideas from the theory of Causal Sets Bombelli et al. (1987). The present work is notably conceptually similar to the hyperbolic disk embedding approach Suzuki et al. (2019) that embeds a set of symbolic objects with a partial order relation [symbol] as generalised formal disks in a (quasi-)metric space (X, d). A formal disk (x, r)∈X× [symbol] is defined by a center x∈X and a r∈ [symbol] (e.g. Suzuki et al. generalise the standard definition of a formal disk/ball to allow for negative radii). Inclusion of disks defines a partial order on formal disks, which enables a natural representation of partially ordered sets as sets of formal disks.

(x,r) [symbol] (y,s)⇔d(x,y)≤r−s.

These approaches all retain the partial-order transitivity assumption where squared distances decrease monotonically into the future and past. This assumption is relaxed herein, alongside considering graphs with cycles and manifolds other than Minkowski spacetime.

As described herein, nodes are points on a manifold [symbol] , the probability of edges are functions of the node coordinates, and the challenge is to infer the optimal embeddings by updating an embedding model via pseudo-Riemannian Stochastic Gradient Descent (SGD) on the node coordinates.

Although the following sections include further examples and/or modifications for further describing the embedding model, cost functions, link prediction function and the mathematical functions and the like according to the invention, these are described for simplicity, by way of example only and the invention is not so limited, thus it is to be appreciated by the skilled person that one or more features, components and/or equations described in the following sections for implementing and/or using the embedding model/link prediction/cost functions used for embedding graphs in non-Euclidean spaces and/or pseudo-Riemannian spaces using pseudo-Riemannian SGD and/or any other suitable SGD algorithm for embedding a graph in a non-Euclidean space/geometry and the like sections may be applied in relation to the invention and/or as the application demands.

The key difference between gradient-based optimisation of smooth functions f on Euclidean vs. any non-Euclidean manifolds described herein is that for the latter, the trivial isomorphism, for any p∈M, between a manifold M and the tangent space T_{P}M no longer holds in general. In particular, the SGD update step p′←p−λ∇f|p for learning rate λ and gradient ∇f is generalised in two areas Bonnabel (2013):

First, in the case of Riemannian manifold optimization, ∇f is replaced with the Riemannian gradient vector field

∇f→grad f:=g−1df, (1)

where g−1: T*ₚM→T_{P}M is the inverse of the positive definite metric g, and df the differential one-form. Second, the exponential map expₚ: T_{P}M→M generalises the vector space addition in the update equation. For any vₚ∈T_{P}M the first-order Taylor expansion is

f(expₚ(Vp))≈f(p)+g(grad f|p,Vp), (2)

from which infer that grad f defines the direction of steepest descent, i.e. the Riemannian-SGD (RSGD) update step is simply

p^{j}←expₚ(−λ grad f|p). (3)

The classes of manifolds considered here all have analytic expressions for the exponential map (see below). The curves traced out by expp(tvp) for t∈R are called geodesics—the generalisation of straight lines to curved manifolds.

On the other hand, a pseudo-Riemannian (or, equivalently, semi-Riemannian) manifold is a one where g is non-degenerate but no longer positive definite. If g is diagonal with ±1 entries, it is a Lorentzian manifold. If g has just one negative eigenvalue, it is commonly called a spacetime manifold. vp is labelled timelike if g(vp, vp) is negative, spacelike if positive, and lightlike or null if zero.

It was first noted in Gao et al. (2018) that grad f is not a guaranteed ascent direction when optimising f on pseudo-Riemannian manifolds, because its squared norm is no longer strictly positive, see above equation (2). For diagonal coordinate charts one can simply perform a Wick-rotation Visser (2017); Gao et al. (2018) to their Riemannian counterpart and apply above equation (3) legitimately; in all other cases, additional steps are required to reintroduce the guarantee (see below equations (11)).

Minkowski spacetime is the simplest Lorentzian manifold with metric g=diag(−1, 1, . . . , 1). The N+1 coordinate functions are (x0, x1, . . . , xN) (x0, x) with x0 the time coordinate. The squared distance s² between two points with coordinates x and y is

$${s}^{2} = - {( x 0 - y 0 )}^{2} + {\sum }_{i = 1}^{N} {( xi - yi )}^{2} . \qquad ( 4 )$$

Because the metric is diagonal and flat, the RSGD update is made with the simple map

expₚ(Vp)=p+Vp, (5)

where vp is the vector with components (vp)i=δ^{ij}(dfp)j, where δ^{ij} is the identity Euclidean metric.

The (N+1)-dimensional anti de-Sitter spacetime AdS_{N} can be defined as an embedding in (N+2)-dimensional Lorentzian manifold (L, gL) with two time coordinates. Given the canonical coordinates (x−1, x0, x1, . . . , xN)≡(x−1, x0, x), AdS_{N} is the quadric surface defined by gL(x, x)≡(x, x)L=−1, or in full,

−x₋₁²−x₀²+x₁²+ . . . +x_{N}²=−1. (6)

Another useful set of coordinates involves the polar re-parameterization (x−1, x0)→(r, θ):

x₋₁=r sin θ,x0=r cos θ, (7)

where by simple substitution

$$r ≡ r ( x ) = {( 1 + {\sum }_{i = 1}^{N} {x}_{i}^{2} )}^{1 / 2} \qquad ( 8 )$$

define a circle time coordinate to be the arc length

$$t := r θ = \{ r ( \frac{{x}_{- 1}}{r} ) {x}_{0} \geq 0 r ( π - ( \frac{{x}_{- 1}}{r} ) ) {x}_{0} < 0 \qquad ( 9 )$$

with x-dependent periodicity t˜t+2πr(x).
The canonical coordinates and metric gL are not intrinsic to the manifold, so the pseudo-Riemannian gradient from equation (1) must be treated with the projection operator Πₚ: TₚL→TₚAdS_{N}, defined for any vₚ∈TₚL to be Robbin & Salamon (2013).

Πₚvₚ=vₚ+gL(vₚ,p)p. (10)

Furthermore, as proved recently in Law & Stam (2020) for general quadric surfaces, one can sidestep the need to perform the computationally expensive Gram-Schmidt orthogonalization by implementing a double projection, i.e. having

ζp=Πp(g_{L}⁻¹(Πp(g_{L}⁻¹df))) (11)

as our guaranteed descent tangent vector.
The squared distance s² between p, q∈AdS_{N} is given by

$${s}^{2} = \{ \begin{matrix}- {\vert {cos}^{- 1} ( - {〈 p , q 〉}_{L} ) \vert}^{2} , - 1 < {〈 p , q 〉}_{L} \leq 1 \\ {( {cosh}^{- 1} ( - {〈 p , q 〉}_{L} ) )}^{2} , {〈 p , q 〉}_{L} < - 1 \\ 0 , {〈 p , q 〉}_{L} = - 1 \\ - {π}^{2} , {〈 p , q 〉}_{L} > 1\end{matrix} \qquad ( 12 )$$

where the first three cases are the squared geodesic distances between time-, space-, and lightlike separated points respectively. For <p, q>_{L}>1, there are no geodesics connecting the points. However, it would require a smooth loss function in s² with complete coverage for all p, q pairs, so s² is set to the value at the timelike limit <p, q>_{L}=1.
The exponential map is given by

$$( {ζ}_{p} ) = \{ ( ‖ {ζ}_{p} ‖ ) p + ( ‖ {ζ}_{p} ‖ ) \frac{{ζ}_{p}}{‖ {ζ}_{p} ‖} , ( ‖ {ζ}_{p} ‖ ) p + ( ‖ {ζ}_{p} ‖ ) \frac{{ζ}_{p}}{‖ {ζ}_{p} ‖} p + {ζ}_{p} \qquad ( 13 )$$

again for the time-, space-, and lightlike ζp respectively, and where ∥ζp∥≡\sqrt{|g_{L}(ζₚ, ζₚ)|}

The Fermi-Dirac (FD) distribution function is a class of probability function for assessing a directed edge between any two nodes in a graph. FD distribution function, where α=1 is the usual parameterization:

$$F ( τ , r , α ) ( x ) := \frac{1}{( {e}^{( α x - r ) / τ} + {1}^{′} )} \qquad ( 14 )$$

with x∈R and parameters τ, r≥0 and 0≤α≤1, is used to represent the probability of undirected graph edges as a function of node embedding distances Krioukov et al. (2010); Nickel & Kiela (2017). For general directed graphs one needs to specify a preferred direction in the embedding space. This is the case where the probability function is isotropic but that the features of the graph enables a form of ‘spontaneous symmetry breaking’, where the node embeddings identifies a natural direction, i.e. tree-like graphs and hyperbolic embeddings where the direction of exponential volume growth lines up with the exponential growth in the number of nodes as one goes up the tree. However for general directed graphs, an explicit symmetry breaking term in the function is likely needed. This initial directed approach is taken in Suzuki et al. (2019), using the radius coordinate, and our method follows this same principle.

F(τ1,τ2,α,r,k)(p,q):=k(F1F2F3) (15)

For spacetime manifolds, the time dimension is the natural coordinate, indicating the preferred direction. For two points p, q∈M, it is proposed that the following distribution F which refers to as the Triple Fermi-Dirac (TFD) function: where k>0 is a tunable scaling factor and

F1:=F(τ₁,r,1)(s²), (16)

F2:=F(τ₂,0,1)(−Δt), (17)

F3:=F(τ₂,0,Δ)(Δt), (18)

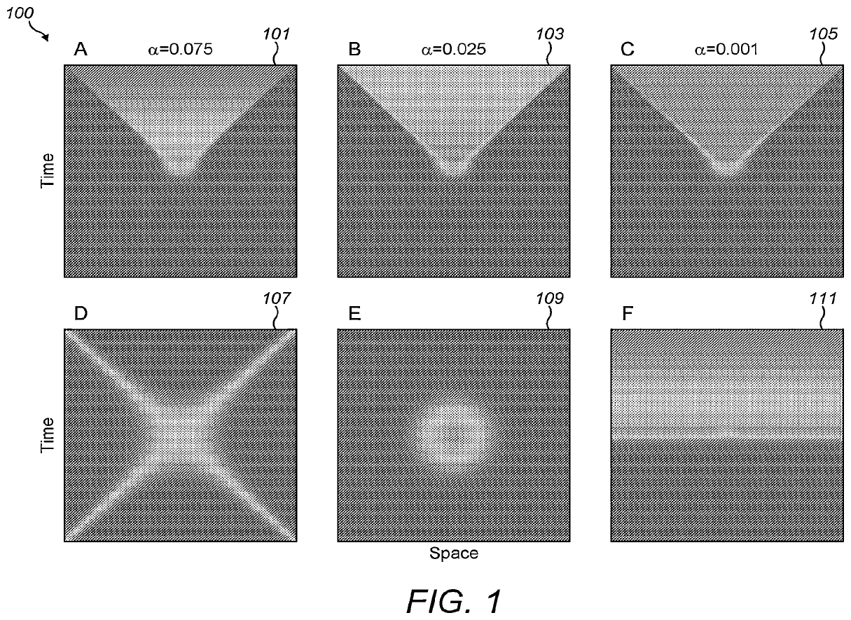

are three FD distribution terms. τ1, τ2, r and α are the parameters from the component FD terms, equation (14), s² the squared geodesic distance between p and q, and Δt the time coordinate difference, which in the case of Minkowski spacetime, is simply x0(q)−x0(p). It is easy to see that for k≤1, F (p, q) is a valid probability value between 0 and 1.
The motivations behind equation (15) can be understood by way of a series of graph plots of F and its component FD terms over a 2D Minkowski spacetime (see FIG. 1).

Shown in FIG. 1 are six graph plots 100 representing the TFD function on the Euclidean manifold (F), alongside just the F1 FD distribution (E). Specifically in the figure the (labelled) plot A 101, plot B 103, plot C 105 illustrates are different representations of 2D Minkowski spacetime in respect of varying the parameter a in the TFD function F, see equation (15). Plot D 107 refers to FD function F1, see equation (16) in Minkowski space. Plot E 109 refers to F1 in Euclidean space and plot F 111 refers to F in Euclidean space. Concretely it is demonstrated that the TFD function combines with the pseudo-Riemannian metric structure to encode three specific inductive biases inherent in general directed graphs: 1. the co-existence of semantic and edge-based similarities, 2. the varying levels of transitivity, and 3. the presence of graph cycles. In addition, the TFD function is just as applicable on Riemannian spaces, as long as one designates a coordinate to be the time dimension.

For a typical graph, a pair of graph vertices x, y can be similar in two ways. They could define an edge, in which case they are simply neighbors, or they could have overlapping neighbor sets Nx and Ny. However, in Riemannian manifold graph embedding models, where node distances determine edge probabilities, a high degree of this latter semantic similarity suggests that x and y are in close proximity, especially if both Nx and Ny are themselves sparsely connected Sun et al. (2015). This can be in conflict with the absence of an edge between the vertex pair.

Embedding graphs in a spacetime manifold resolves this inconsistency—given a pair of vertices that do not share an edge, there is no constraint on the Jaccard index (Nx∩Ny)/(Nx∪Ny). This claim can be verified by examining the contribution from the first FD term F1, see equation (16) in the TFD function. As shown in FIG. 1, plot D 107 F1 is low when, when x and y are spacelike separated and high when within each other's past and future lightcones. Our claim can then be rephrased in geometric terms by stating that two spacelike separated points (hence low edge probability) can have an arbitrarily large overlap in their lightcones (and hence in their neighbor sets).

Simply using F1 for edge probabilities is problematic in two ways. First, the past and future are indistinguishable, and hence too the probabilities for both edge directions of any node pair. Second, lightcones, being cones, define a strict partial ordering on the graph. Specifically, as a function of s² alone the probability function that predicts the directed chain

p1→p2→p3 (19)

will always predict the transitive relation p1→p3 with a higher probability than either p1→p2 and p2→p3, see equation (16). This is a highly restrictive condition imposed by a naive graph embedding on a pseudo-Riemannian manifold.

Both the need for edge anti-symmetries and for flexible transitive closure constraints via the other two FD terms F2 and F3 from equation (17) and (18). Both terms introduce exponential decays into the respective past and future timelike directions, thereby breaking the strict partial order. Crucially, they are not time-symmetric due to the parameter α in F3, which introduces different decay rates.

Further shown in FIG. 1, plot A 101, where the TFD has a local maximum in the near timelike future. The α controls the level of transitivity in the inferred graph embeddings, see in FIG. 1 (plots A-C, 101, 103, 107). Euclidean disk embeddings Suzuki et al. (2019) can be viewed as approximately equivalent to that of α=0 case in flat Minkowski spacetime, where the region of high edge probability extends far out into the future lightcone.

Another feature of the TFD probabilistic model in equation (15) is that the lightcone boundaries are soft transitions that can be modified by adjusting the temperature hyperparameters τ1 and τ2. Specifically, short (in a coordinate-value sense) directed links into the past or in spacelike directions relative to the node of origin have probabilities close to ½, as can be verified by a Taylor expansion of equation (15) around p=q=0 (see FIG. 1, plot D 107).

This feature alone does not constitute a sufficient basis to promote pseudo-Riemannian embeddings with the TFD distribution as a model for cyclic graph representations. Embedding long directed cycles in this way is not very efficient. For example, a length-n chain with O(n²) number of possible (and missing) transitive edges would be probabilistically indistinguishable from a fully-connected clique. For this we turn our attention to the global features of the manifold.

The problem with embedding cycles via a model that favors future-timelike directed links is the unavoidable occurrence of at least one, low-probability, past-directed edge. Here we propose a circular time dimension as a global topological solution. We consider two such pseudo-Riemannian manifolds with a S¹×R^{N} topology—a modified cylindrical Minkowski spacetime and Anti-de Sitter spacetime.

For an (N+1)-dimensional spacetime manifold with time coordinates (x₀, x), we construct our cylinder by identifying

x₀˜x₀+nC, (20)

for some circumference C>0 and n∈Z. To ensure a smooth TFD function on the cylinder we define a wrapped TFD function as

$$\tilde{F} ( p , q ) := {\sum }_{- ∞}^{∞} F ( p , {q}^{n} ) , \qquad ( 21 )$$

where x₀(q⁽ⁿ⁾)≡x₀(q)+nC, with all other coordinates equal. Unlike the case of the wrapped normal distribution, there is no (known) closed-form expression for F. However, provided α>0, the exponentially decreasing probabilities from F2 and F3 into the far past and future time directions respectively enables one to approximate the infinite sum in equation (21) by a sum over integers from −m to m. The scaling factor k in equation (15) can be used to ensure max F≤1.

In this topology, the concept of space- and timelike separated points is purely a local feature, as there will be multiple timelike paths between any two points on the manifold. This bears some resemblance to real-world networks, where simple linear pathways are only ever local approximations to a more complex global picture.

Unlike for Minkowski spacetime, AdS already has an intrinsic S¹×R^{N} topology. To adapt the TFD distribution to AdS space, we adopt polar coordinates and let the angular difference between p and q be

θ_{pq}:=θ_{q}−θₚ (22)

where θ is the polar angle from equation (7). Then we define

θt_{pq}:=r_{q}θ_{pq} (23)

Similar to the cylindrical Minkowski case we modify F such that for two points p and q, we have

F(p,q)=F(p,q⁽ⁿ⁾), (24)

where q⁽ⁿ⁾∈AdS_{N} have identical coordinates with q except that

r_{q}(n)=r_{q}+2πnr_{q}, (25)

Δt_{pq}⁽ⁿ⁾:=Δt_{pq}+2πnr_{q}. (26)

The wrapped TFD distribution is identical to equation (21) with Δt_{pq} as the time difference variable in the definition of F equation (15).

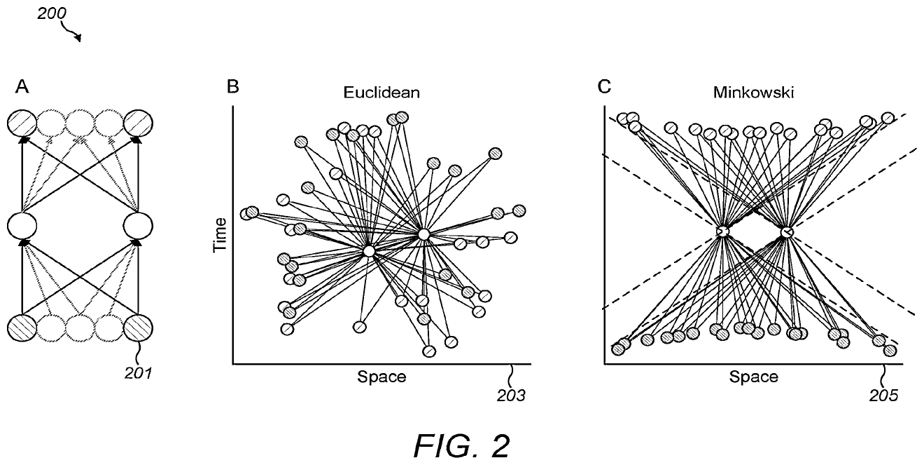

In event that unconnected node pairs having arbitrarily large overlapping neighbor sets when features are encoded, it may be appropriate to construct a graph consisting of an unconnected node pair, and two large sets of unconnected, common predecessors and successors, see FIG. 2, plot A 201. The Euclidean embedding model trained with the FD edge probability function cannot reconcile the high semantic similarity of the node pair with the absence.

FIG. 2 shows graph representations 200 of Tri-partite, Euclidean embeddings, and Minhowski embeddings. In particular, Plot A 201 refers to the Tri-partite graph of an unconnected node pair with large common predecessors and successors. Plot B 203 refers to Euclidean embeddings with edge probability between the node pair as 0.50. Plot C 205 refers to Minkowski embeddings with edge probability of 0.01.

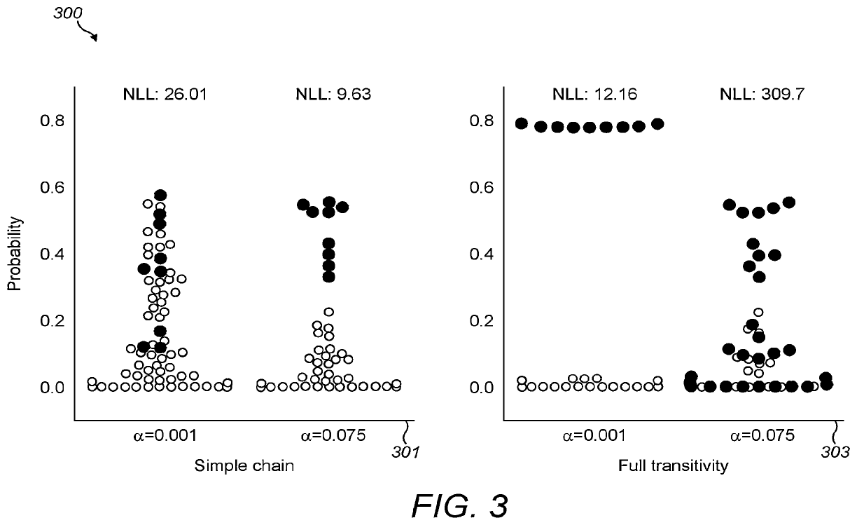

FIG. 3 is a data representation 300 showing the performance of Minkowski embeddings. On the x-axis is the α values, and the y-axis is probabilities. Performance of Minkowski embeddings on two example graphs (respectively Sample Chain 301 and Full Transitivity 303) for varying α values in the TFD function are illustrated in the figure. The left is a simple chain of 10 nodes (Simple Chain 301), and the right is a ten-node chain with all transitive edges (Fully Transitive 305). The α values correspond to two probability landscapes depicted in FIG. 1. Black markers indicate positive edges. Also annotated is the negative log likelihood (NLL) of the graph.

FIG. 4A is an illustration of a 5-node chain 400 used as an example of training data. 5-node chain used as training data. The 5-node chain includes nodes 1-5, 401, 402, 403, 404, and 405. The nodes form a cyclic graph directed in a clock-wise manner. FIG. 4B is cylindrical Minkowski embeddings of 5-node chain 410. FIG. 4C is AdS embeddings of 5-node chains 420. FIG. 4D is 2D projections of learned embeddings 430. For AdS embeddings, two time dimensions are shown, with spatial position indicated by marker size. To highlight circular time in AdS space, we overlay an illustrative circle over the nodes. FIG. 4E is Edge probabilities for 5-node cycle using Minkowski (Min.) 440, cylindrical Minkowski (Cyl. Min.) and Anti-de Sitter (AdS) embeddings. Positive edges are indicated in black.

In the context of previous figures, of an edge; the pair of nodes are unavoidably closer to each other than the majority of their neighbor connections, see for example FIG. 2, plot B 203. On the contrary, the Minkowski model effectively encodes the tri-partite graph as three sets of spacelike separated points with high degree of overlap in the lightcones of the nodes in the pair, see for example figure FIG. 2, plot C 205.

Function F can be tuned to encode networks with varying proportion of transitive relations. A simple 10-node chain and a fully transitive variant could be constructed to explore the ability to tune the TFD loss to best capture graph transitive structure, using the alpha parameter to vary probability decay in the time direction. Using two α values, α=0.001 and α=0.075, corresponding to the heatmaps shown in FIG. 1 plot A 101 and plot C 103. And, in FIG. 3, it could be seen that smaller values of α are able to more successfully capture full transitivity. In the case of a simple chain, setting α=0.001 results in a higher probability being assigned to negative edges, compared to the α=0.075 case.

Regarding graph cycles wrap around the S1 dimension, a simple five-node loop (see FIG. 4A) in 2D Minkowski, cylindrical Minkowski (see FIG. 4B), and anti de-Sitter (see FIG. 4C) spacetimes could be embedded. In all three manifold embeddings, the true node ordering is recovered as reflected in the ordered time coordinates (see FIG. 4B-D). However for the Minkowski manifold, there is one positive edge (1 2 in this case) that unavoidably gets assigned an incorrectly low probability. On the contrary, the S1 time dimension for cylindrical Minkowski and AdS spacetime ensures that all edges have high probabilities (see FIG. 4E), thereby demonstrating the utility of the circle time dimension.

Table 1 below relates to link prediction for directed cyclic graphs. The table shows that the median average precision (AP) percentages across random initializations (N=20), calculated on a random held-out test set, for different embedding dimensions d. Highlighted in grey or italicized is the top-performing model for the given dimension; Annotated in bold is the top-performing model overall (higher is better). For reference, the asymptotic random baseline AP is 20%.

TABLE 1

| | Duplication Divergence Model | | | | | DREAM5: in silico | | | | |
|---|---|---|---|---|---|---|---|---|---|---|
| | d = 3 | d = 5 | d = 10 | d = 50 | d = 100 | d = 3 | d = 5 | d = 10 | d = 50 | d = 100 |
| Euclidean + | 37.8 | 39.4 | 39.0 | 38.9 | 38.9 | 29.4 | 32.9 | 39.7 | 39.8 | 34.8 |
| FD | | | | | | | | | | |
| Hyperboloid + | 36.3 | 37.5 | 38.2 | 38.2 | 38.1 | 28.8 | 46.8 | 50.8 | 50.9 | 52.5 |
| FD | | | | | | | | | | |
| Minkowski + | 43.7 | 47.5 | 48.5 | 48.5 | 48.5 | 36.3 | 43.1 | 51.2 | 57.7 | 58.0 |
| TFD | | | | | | | | | | |
| Anti de-Sitter + | 50.1 | 52.4 | 56.2 | 56.3 | 56.8 | 38.1 | 45.2 | 51.9 | 55.6 | 56.0 |
| TFD | | | | | | | | | | |
| cylindrical | 55.8 | 61.6 | 65.3 | 65.7 | 65.6 | 41.0 | 48.4 | 56.3 | 58.9 | 61.0 |
| Minkowski + | | | | | | | | | | |
| TFD | | | | | | | | | | |

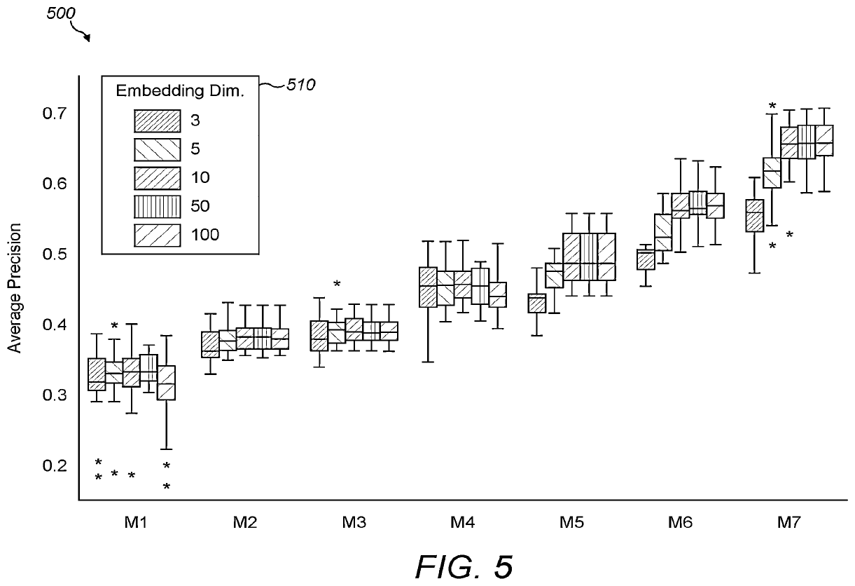

Further to Table 1 is an ablation study to examine the relative contributions of 1. the pseudo-Riemannian geometry, as reflected in the presence of negative squared distances, 2. the global cylindrical topology, and 3. TFD vs. FD likelihood model. The results are presented in FIG. 5. The results can be understood that the importance of all of the components in the superior performances of the anti-de Sitter and cylindrical Minkowski manifold embeddings, with the S¹ topology arguably being the biggest contributor to performance.

FIG. 5 is a representation 500 of average precision values for models M1 to M7. In the figure, the average precision values are shown in regards to link prediction on the Duplication Divergence Model graph across manifold/likelihood model combinations and embedding dimensions. The models are annotated on the figure with respective embedding dimensions 510. The x-axis are models M1 to M7. The y-axis is average precision as values under 1. The respective models are M1: Euclidean manifold with TFD, M2: Hyperboloid+FD, M3: Euclidean with FD, M4: cylindrical Euclidean+TFD, M5: Minkowski+TFD, M6: Anti-de Sitter+TFD, M7: cylindrical Minkowski+TFD.

Table 2 below shows the performance of the Pseudo-Riemannian approach on the link prediction task, benchmarked against a set of competitive methods (results taken from Suzuki et al. (2019)). It breaks down the methods into flat- and curved-space embedding models. It could be seen that our approach outperforms all the other flat-space as well as some curved-space methods, including Poincare embeddings Nickel & Kiela (2017). Furthermore, the Minkowski embedding model achieves competitive performance with hyperbolic and spherical approaches. Considering that these methods are well suited to representing hierarchical relationships central to WordNet, this result shows that Pseudo-Riemannian models are highly capable of representing hierarchies by encoding edge direction. Furthermore, we can show that the representational power of (a special case of) the Triple Fermi-Dirac Probability on Flat Minkowski spacetime is similar to that of Euclidean Disk Embeddings. The difference in performance between Euclidean Disk Embeddings and our model on this task could be due to the additional flexibility allowed by the TFD probability function or in differences in the resulting optimisation problem, something which could be further explored in future work.

TABLE 2

| | d = 5 | | d = 10 | |
|---|---|---|---|---|
| Transitive Closure Percentage | 25% | 50% | 25% | 50% |
| Minkowski + TFD (Ours) | 86.2 | 92.1 | 89.3 | 94.4 |
| Order Emb. Vendrov et al. (2016) | 75.9 | 82.1 | 79.4 | 84.1 |
| Euclidean Disk Suzuki et al. (2019) | 42.5 | 45.1 | 65.8 | 72.0 |
| Spherical Disk Suzuki et al. (2019) | 90.5 | 93.4 | 91.5 | 93.9 |
| Hyperbolic EC Ganea et al. (2018) | 87.1 | 92.8 | 90.8 | 93.8 |
| Hyperbolic Disk Suzuki et al. (2019) | 81.3 | 83.1 | 90.5 | 94.2 |
| Poincare Emb. Nickel & Kiela (2017) | 78.3 | 83.9 | 82.1 | 85.4 |

In Table 2, F1 percentage score on the test data of WordNet. The best flat-space performance (top-half) for each dataset/embedding dimension combination has been highlighted in gray or italicized and the best overall is in bold. The benchmark method's results were taken from Suzuki et al. (2019).

To conclude, the real world graphs are riddled with confounds, from intricate architectures to unexpected missing links. While standard embedding approaches using Riemannian manifolds have made significant advances in representing complex graph topologies, there are still areas in which these methods fall short, due largely to the inherent constraints of the metric spaces used, or an overly basic use of pseudo-Riemannian structures. It is demonstrated that the ability of graph embeddings in pseudo-Riemannian manifolds to effectively overcome some of the open areas in graph representation learning, summarized in three key results.

Firstly, anti-de Sitter and cylindrical Minkowski embeddings are able to successfully represent directed cyclic graphs using the novel Triple Fermi-Dirac loss function and the cylindrical topology of the manifolds.

Secondly, pseudo-Riemnannian embeddings are able to disam-biguate direct neighbors from functionally similar nodes, as demonstrated in a series of experiments on synthetic datasets.

Finally, Minkowski embeddings strongly outperform Riemannian baselines on a link prediction task in directed cyclic graphs, and achieve results comparable with state-of-the-art methods on DAGs.

Furthermore, applying our pseudo-Riemannian approach allowed us to effectively lift the constraints of transitivity in node possets due to the temporal decay of the TFD probability function. Using these characteristics, we demonstrate superior performance on a number of directed cyclic graphs: the duplication-divergence model, and a set of three DREAM5 gold standard gene regulatory networks.

The invention is designed to explore the potential of pseudo-Riemannian embeddings to express critical features of graph objects. Within the scope of this paper, the intent is to demonstrate key properties of these embeddings on toy and synthetic datasets, with performance on WordNet serving as the primary basis for comparison with existing state-of-the-art methods. There are two direct avenues for further research in this area. It is intend to continue to explore the characteristics of these manifolds, while also looking at the ability of variants like de Sitter space to capture unique graph structures. Additionally, beyond link prediction in directed graphs, inferring causal networks using observational data is a critical problem with a wide range of applications—in biology, for example, inferring gene regulatory networks from gene expression data is a research area of high interest. In an application like this, sparse “ground-truth” connectivity is already known, therefore a logical extension of the model presented here would be a hybrid version that combines directed graph link prediction with a more standard, similarity-based method incorporating gene expression correlation information. With these innovations, we hope to continue optimizing the ability of physics-inspired spacetimes to capture important, complex graph topologies, and solve pressing problems of network inference.

Furthermore the invention is intended to be used in drug target identification, in particular, to identify therapeutic targets that are causally linked to diseases or mechanisms of interest. Namely, using a directed subset of our knowledge graph, we can infer therapeutic genes for a given mechanism or disease with higher accuracy, given this model's increased ability to model complex graph structures. Given a set of genes that have shown efficacy in assay, we can use pseudo-Riemannian embeddings to infer useful, causally linked genes to those successful in assay, in order to identify similar and possibly novel genes that successfully modulate disease biology.

A different application for of the invention is in precision medicine. For example, in terms of distribution of highly proliferating myofibroblasts (PMpt): one of the main objectives of PMpt is to identify and understand disease endotypes. This could be done using our pseudo-Riemannian embeddings that can be used to enrich existing disease-disease graphs built from disease comorbidity data by inferring missing links. This could then deepen the understanding of disease specificity for uncovered endotypes. Existing gene regulatory networks that have been inferred using observational data can be augmented.

Another area relevant to this invention may be used is in chemistry. The ability of this model to disambiguate semantic similarity and direct linkage could be applied to the Hit Expansion stage gate in our Al Chemistry pipeline, allowing us to differentially infer molecules that have similar modes of action to successful molecules in Hit ID and are directly linked (via literature, prior experimentation, etc.) to molecules of interest, and those that are independent.

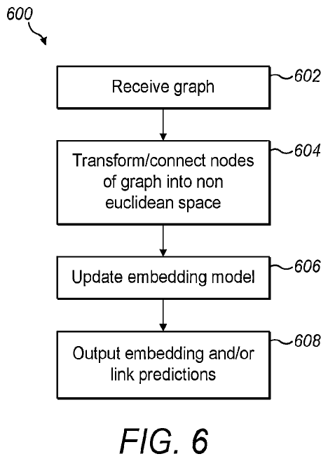

FIG. 6 is a flow diagram illustrating an example process 600 for generating an embedding of a graph according to the invention. The embedding model(s), cost functions, and/or TFDs, and the like as described with reference to FIGS. 1 to 5 and/or as described herein, may be further modified, and/or combined or generalised based on the process 600 as described with reference to FIG. 6. The graph includes a plurality of nodes and each node includes an edge to another one or more of the nodes. The process 600 may further include one or more of the following steps of: In step 602, receiving data representative of at least a portion of the graph; In step 604, transforming the nodes of the graph into a non-Euclidean geometry; In step 606, iteratively updating an embedding model based the transformed nodes in the non-Euclidean geometry based on a causal loss function and a link prediction function associated with the non-Euclidean geometry; As an option, in step 608, the process 600 may output a embedding of the graph and/or one or more link predictions and the like.

The output graph embedding and the link prediction function may be used for link prediction. For example, link prediction in a graph may include: generating a graph embedding according to process 600 and/or as herein described with reference to any of the figures, combinations thereof, modifications thereto and/or as the application demands; selecting at least a first and second node coordinate from the graph embedding; outputting a directed link prediction based on inputting the selected first and second node coordinate to the link prediction function, where the directed link prediction includes an indication of the likelihood of a link relationship existing between the first and second node coordinates.

Alternatively or additionally, the output graph embedding and the link prediction function may be used for predicting a directed relationship between entities in a graph. For example, this may include: generating a graph embedding based on the graph embedding according to process 600 and/or as herein described with reference to any of the figures; and selecting at least a first and second entity node coordinate from the graph embedding, the at least first and second entity node coordinates associated with at least the first and second entity of the graph; outputting a directed relationship prediction based on inputting the selected at least first and second entity node coordinate to the link prediction function, where the directed relationship prediction includes an indication of the likelihood of a relationship link existing between the at least first and second entity node coordinates.

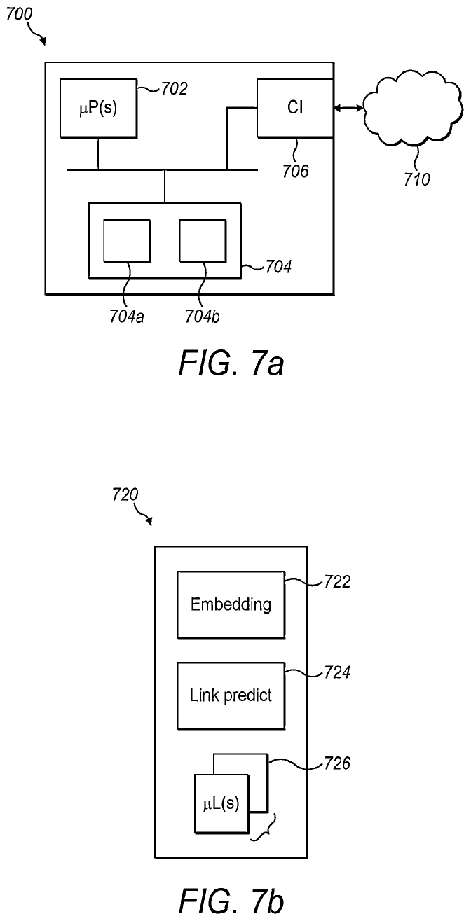

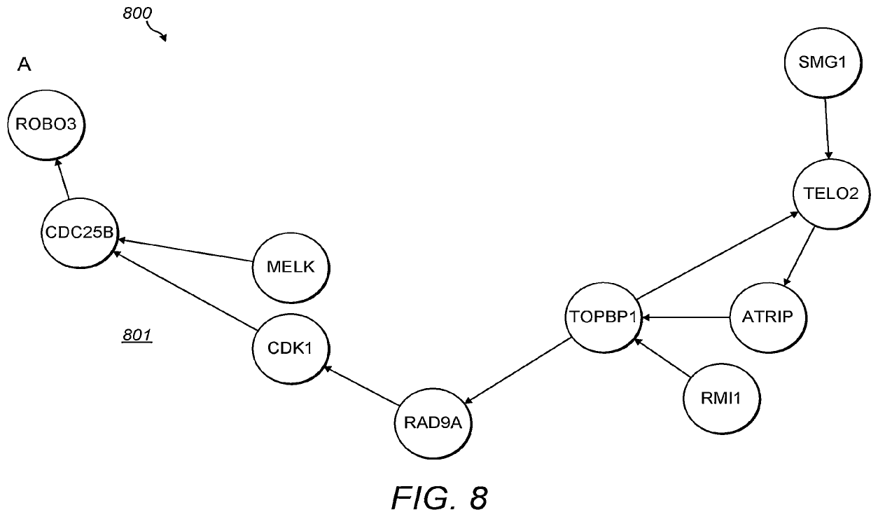

FIG. 7a is a schematic diagram illustrating a computing device 700 that may be used to implement one or more aspects of the embedding model and/or graph embedding system, graph embedding according to the invention and/or includes the methods, process(es) and/or system(s) and apparatus as described with reference to FIGS. 1a-6, combinations thereof, modifications thereto and/or as described herein. Computing device 700 includes one or more processor unit(s) 702, memory unit 704 and communication interface 706 in which the one or more processor unit(s) 702 are connected to the memory unit 704 and the communication interface 706. The communications interface 706 may connect the computing device 700 over a network 710 with one or more databases or other processing system(s) or computing device(s). The memory unit 704 may store one or more program instructions, code or components such as, by way of example only but not limited to, an operating system 704a for operating computing device 700 and a data store 704b for storing additional data and/or further program instructions, code and/or components associated with implementing the functionality and/or one or more function(s) or functionality associated with one or more of the method(s) and/or process(es) of the apparatus, module(s), mechanisms and/or system(s)/platforms/architectures as described herein and/or as described with reference to at least one of figure(s).

Further aspects of the invention may include one or more apparatus and/or devices that include a communications interface, a memory unit, and a processor unit, the processor unit connected to the communications interface and the memory unit, wherein the processor unit, storage unit, communications interface are configured to perform the system(s), apparatus, method(s) and/or process(es) or combinations thereof as described herein with reference to figures.

FIG. 7b is a schematic diagram illustrating a system 720 for generating graph models according to the invention. The system 720 includes an embedding generation module 722 configured to generate an embedding model, generate an embedding and/or output a graph embedding on of an entity-entity graph or a directed graph. The entity-entity graph or graph including a plurality of entity nodes in which each entity node is connected to one or more entity nodes of the plurality of entity nodes by one or more corresponding relationship edges. The graph embedding includes a plurality of node coordinates of an N-dimensional non-Euclidean space including, but not limited to, a pseudo-Riemannian geometry; a pseudo-Riemannian geometry or space; a Minkowski geometry or space; an anti-de Sitter geometry or space; an hyperbolic geometry or space; any other suitable geometry or spacetime geometry/space; combinations thereof, modifications thereof and/or as herein described. The system 720 further includes an link prediction module 724 configured to predict link relationships and/or provide a prediction or probability of whether a link and/or relationship exists between a first entity and second entity node of a graph embedding generated by the embedding generation module 722. The system 720 may further include a machine learning module 726 configured to: use the graph embedding of the embedding generation module 722 and/or one or more link predictions from the link prediction module 724 for training the ML model and/or for input to an ML model configured for operating on the data represented in the graph and/or graph embedding of the graph and the like. The system 720 may include the functionality of the method(s), process(es), and/or system(s) associated with the invention as described herein, or as described with reference to figures for providing an embedding model, an graph embedding, link predictions, further downstream ML model(s) and/or process(es) associated thereto, and the like.

As described herein and/or in FIG. 7b, one or more ML models may be trained and/or use a graph embedding and/or link prediction outputs that may be output from the embedding model and/or link prediction function and the like as described with reference to figures, modifications thereof, combinations thereto and/or as herein described. Such ML model(s) may be trained and/or generated using ML algorithms(s)/ML technique(s) that can be used to train and generate one or more trained models having the same or a similar output objective associated with compounds. The graph embeddings as described herein according to the invention may be used in training data sets for input to ML technique(s)/algorithm(s) in order to output a trained ML model. The graph embeddings as described herein according to the invention may be used as input to ML technique(s)/algorithm(s) in order to output a trained ML model. ML technique(s) may comprise or represent one or more or a combination of computational methods that can be used to generate analytical models and algorithms that lend themselves to solving complex problems such as, by way of example only but is not limited to, prediction and analysis of complex processes and/or compounds. ML techniques can be used to generate analytical models associated with compounds for use in the drug discovery, identification, and optimisation and other related informatics, cheminformatics and/or bioinformatics fields.

FIG. 8 is a demonstration of training pseudo-Riemannian embeddings (flat Minkowski) on an example dataset 800. Shown in Plot A 801 is a subset of a particular protein-protein interaction network used in model training. The interacting nodes on the graph represent abbreviated protein acronyms (ROBO3, CDC25B, MELK, CDK1, RAD9A, TOPBP1, RME1, ATRIP, TELO2, SMG1) Plot B 803 illustrates the random initializations of a set of 2-dimensional embeddings of the protein-protein interaction of the same proteins. Shown in plot C 805 is the trained set of embeddings. Notable is the ability of the model to capture the TOBP1-TELO2-ATRIP cycle—a feature unique to this embedding type. Finally, plots D 804 and E 805 show the corresponding probability equivalents of the graphs shown in B 802 and C 803, with true edges denoted in black. In plot D 804 is the pre-training process, the model is unable to distinguish positive and negative edges. After training in plot E 805, however, positive edges are ranked significantly higher than negative edges, most of which are assigned a probability of zero.

Examples of ML technique(s) that may be used by the graph embeddings generated by the embedding model according to the invention and/or as described herein may include or be based on, by way of example only but is not limited to, any ML technique or algorithm/method that can be trained on a labelled and/or unlabelled datasets derived from the graph embeddings to generate a model associated with the labelled and/or unlabelled dataset, one or more supervised ML techniques, semi-supervised ML techniques, unsupervised ML techniques, linear and/or non-linear ML techniques, ML techniques associated with classification, ML techniques associated with regression and the like and/or combinations thereof. Some examples of ML techniques may include or be based on, by way of example only but is not limited to, one or more of active learning, multitask learning, transfer learning, neural message parsing, one-shot learning, dimensionality reduction, decision tree learning, association rule learning, similarity learning, data mining algorithms/methods, artificial neural networks (NNs), deep NNs, deep learning, deep learning ANNs, inductive logic programming, support vector machines (SVMs), sparse dictionary learning, clustering, Bayesian networks, reinforcement learning, representation learning, similarity and metric learning, sparse dictionary learning, genetic algorithms, rule-based machine learning, learning classifier systems, and/or one or more combinations thereof and the like.

Some examples of supervised ML techniques may include or be based on, by way of example only but is not limited to, ANNs, DNNs, association rule learning algorithms, a priori algorithm, Éclat algorithm, case-based reasoning, Gaussian process regression, gene expression programming, group method of data handling (GMDH), inductive logic programming, instance-based learning, lazy learning, learning automata, learning vector quantization, logistic model tree, minimum message length (decision trees, decision graphs, etc.), nearest neighbour algorithm, analogical modelling, probably approximately correct learning (PAC) learning, ripple down rules, a knowledge acquisition methodology, symbolic machine learning algorithms, support vector machines, random forests, ensembles of classifiers, bootstrap aggregating (BAGGING), boosting (meta-algorithm), ordinal classification, information fuzzy networks (IFN), conditional random field, anova, quadratic classifiers, k-nearest neighbour, boosting, sprint, Bayesian networks, Naïve Bayes, hidden Markov models (HMMs), hierarchical hidden Markov model (HHMM), and any other ML technique or ML task capable of inferring a function or generating a model from labelled training data and the like.

Some examples of unsupervised ML techniques may include or be based on, by way of example only but is not limited to, expectation-maximization (EM) algorithm, vector quantization, generative topographic map, information bottleneck (IB) method and any other ML technique or ML task capable of inferring a function to describe hidden structure and/or generate a model from unlabelled data and/or by ignoring labels in labelled training datasets and the like. Some examples of semi-supervised ML techniques may include or be based on, by way of example only but is not limited to, one or more of active learning, generative models, low-density separation, graph-based methods, co-training, transduction or any other a ML technique, task, or class of supervised ML technique capable of making use of unlabeled datasets and labelled datasets for training (e.g. typically the training dataset may include a small amount of labelled training data combined with a large amount of unlabeled data and the like.

Some examples of artificial NN (ANN) ML techniques may include or be based on, by way of example only but is not limited to, one or more of artificial NNs, feedforward NNs, recursive NNs (RNNs), Convolutional NNs (CNNs), autoencoder NNs, extreme learning machines, logic learning machines, self-organizing maps, and other ANN ML technique or connectionist system/computing systems inspired by the biological neural networks that constitute animal brains and capable of learning or generating a model based on labelled and/or unlabelled datasets. Some examples of deep learning ML technique may include or be based on, by way of example only but is not limited to, one or more of deep belief networks, deep Boltzmann machines, DNNs, deep CNNs, deep RNNs, hierarchical temporal memory, deep Boltzmann machine (DBM), stacked Auto-Encoders, and/or any other ML technique capable of learning or generating a model based on learning data representations from labelled and/or unlabelled datasets.

It is to be appreciated that there are a myriad of ML techniques that may be used to train and generate a plurality of trained models, in which each trained model is associated with the same or a similar output objective in relation to compounds. Each of the different ML techniques may use the graph embeddings output by the embedding model or data representative thereof to train and generate each trained model and/or as input to a trained model and the like.

Each of trained model may comprise or represent data representative of an analytical model that is associated with modelling a particular process, problem and/or prediction associated with compounds in the informatics, cheminformatics and/or bioinformatics fields and trained from a training data set and/or from data based on graph embeddings of a graph comprising entity nodes and relationship edges thereto and the like, where the entities are based on data from the informatics, cheminformatics and/or bioinformatics fields.

Examples of output objective(s) and/or modelling a process, problem and/or prediction associated with compounds in the informatics, cheminformatics, and/or bioinformatics fields may include one or more of, by way of example only but is not limited to, compound interactions with other compounds and/or proteins, physiochemical properties of compounds, solvation properties of compounds, drug properties of compounds, structures and/or material properties of compounds and the like etc., and/or modelling chemical or biological problems/processes/predictions of interest that may assist in, by way of example only but is not limited to, the prediction of compounds and/or drugs in drug discovery, identification and/or optimisation.

Other examples of output objectives and/or modelling a process, problem and/or prediction associated with compounds may include, by way of example only but is not limited to, modelling or predicting a characteristic and/or property of compounds, modelling and/or predicting whether a compound has a particular property, modelling or predicting whether a compound binds to, by way of example only but is not limited to, a particular protein, modelling or predicting whether a compound docks with another compound to form a stable complex, modelling or predicting whether a particular property is associated with a compound docking with another compound (e.g. ligand docking with a target protein); modelling and/or predicting whether a compound docks or binds with one or more target proteins; modelling or predicting whether a compound has a particular solubility or range of solubilities, or any other property.

Further examples of output objectives and/or modelling a process, problem and/or prediction associated with compounds, may include, by way of example only but is not limited to, outputting, modelling and/or predicting physiochemical properties of compounds such as, by way of example only but not limited to, one or more of Log P, pKa, freezing point, boiling point, melting point, polar surface area or any other physiochemical property of interest in relation to compounds; outputting, modelling and/or predicting solvation properties of compounds such as, by way of example only but not limited to, phase partitioning, solubility, colligative properties or any other properties of interest in relation to compounds; modelling and/or predicting one or more drug properties of compounds such as, by way of example only but not limited to, dosage, dosage regime, binding affinity, adsorption (e.g. gut, cellular etc.), metabolism, brain penetrance, toxicity and any other drug property of interest in relation to compounds; outputting, modelling and/or predicting binding modes of compounds such as, by way of example only but not limited to, one or more of predictive co-crystal structures of ligands to receptors and the like; outputting, modelling and/or predicting crystal structures of compounds such as, by way of example only but not limited to, one or more of crystal packing of compounds, protein folding, and any other crystal structure type and the like that may be of interest in relation to compounds; outputting, modelling and/or predicting materials properties of compounds such as, by way of example only but not limited to, one or more of conductivity, surface tension, coefficient of friction, permeability, hardness, tensile strength, luminosity etc., and any other material property that may be of interest in relation to compounds; outputting, modelling and/or predicting any other properties of interest, interactions of interest, characteristics of interest, or anything else of interest in relation to compounds in the informatics, cheminformatics and/or bioinformatics fields.

Further examples, embodiments and/or modifications to the embodiments of the invention as described herein are described by one or more of the following numbered clauses.

### CLAUSES

Clause 1. A computer-implemented method of generating an embedding a graph, wherein the graph comprises a plurality of nodes and each node includes an edge, connection, or link to another one or more of the nodes, the method comprising: receiving data representative of at least a portion of the graph; transforming the nodes of the graph into a non-Euclidean geometry; iteratively updating an embedding model based the transformed nodes in the non-Euclidean geometry based on a causal loss function and a link prediction function associated with the non-Euclidean geometry.
Clause 2. The computer-implemented method as described in clause 1, wherein: transforming the nodes of the graph further comprises transforming the nodes of the graph into coordinates of the non-Euclidean geometry; and wherein the embedding model is based on a non-Euclidean stochastic gradient descent algorithm operating on the node coordinates using the causal loss function.
Clause 3. The computer-implemented method as described in clauses 1 or 2, wherein updating the embedding model further includes updating the node coordinates by minimising the causal loss function based on at least the embeddings and the link prediction function.
Clause 4. The computer-implemented method as described in any of clauses 1 to 3, further comprising iteratively updating the embedding model until the embedding model is determined to be trained; a maximum number of iterations has been reached, and/or or until an average loss threshold has been met for all node coordinates; and outputting data representative of the graph embedding once trained.
Clause 5. The computer-implemented method as described in any preceding Clause, wherein the graph is a directed graph.
Clause 6. The computer-implemented method as described in any preceding Clause, wherein the graph is a cyclic directed graph.
Clause 7. The computer-implemented method as described in any of Clauses 1 to 5, wherein the graph is an acyclic directed graph.
Clause 8 The computer-implemented method as described in any preceding Clause, wherein the non-Euclidean geometry is a pseudo-Riemannian geometry.
Clause 9. The computer-implemented method as described in any preceding Clause, wherein the non-Euclidean geometry is a pseudo-Riemannian geometry or space.
Clause 10. The computer-implemented method as described in any preceding Clause, wherein the pseudo-Riemannian geometry or space is a Minkowski geometry or space.
Clause 11. The computer-implemented method as described in any preceding Clause, wherein the pseudo-Riemannian geometry or space is an anti-de Sitter geometry or space or a de-Sitter geometry or space.
Clause 12. The computer-implemented method as described in any preceding Clause, wherein the non-Euclidean geometry or space is a hyperbolic geometry or space.
Clause 13. The computer-implemented method as described in any preceding Clause, wherein the graph is an entity-entity graph comprising a plurality of entity nodes and a plurality of edges, wherein each entity node connects to another entity node via an edge, each edge representing a relationship between said each entity node and the connected said other entity node.
Clause 14. The computer-implemented method as described in any preceding Clause, wherein an entity node in the entity-entity graph represents any entity from the group of: gene; disease; compound/drug; protein; biological entity; pathway; biological process; cell-line; cell-type; symptom; clinical trials; any other biomedical concept; or any other entity with at least an entity-entity relationship to another entity in the entity-entity graph.
Clause 15. The computer-implemented method as described in any preceding Clause, further comprising outputting the embeddings of the graph from the trained entity model for use in downstream process(es) including one or more from the group of: drug discovery; drug optimisation; and/or for any other ML model or training any other ML model for predicting or classifying in a drug discovery or optimisation process.
Clause 16. The computer-implemented method as described in any preceding Clause, further comprising: predicting link relationships between nodes or entity nodes in the embeddings of the graph based on inputting data representative of a first and second node into the link prediction function; and receiving from the link prediction function an indication of the likelihood of a link relationship existing between said first and second node.
Clause 17. A computer-implemented method for link prediction in a graph further comprising: generating a graph embedding according to any of Clauses 1 to 16; and selecting at least a first and second node coordinate from the graph embedding; outputting a directed link prediction based on inputting the selected first and second node coordinate to the link prediction function, wherein the directed link prediction includes an indication of the likelihood of a link relationship existing between the first and second node coordinates.
Clause 18. A computer-implemented method for predicting a directed relationship between entities in a graph further comprising: generating a graph embedding based on the graph in accordance with any of Clauses 1 to 17; and selecting at least a first and second entity node coordinate from the graph embedding, the at least first and second entity node coordinates associated with at least the first and second entity of the graph; outputting a directed relationship prediction based on inputting the selected at least first and second entity node coordinate to the link prediction function, wherein the directed relationship prediction includes an indication of the likelihood of a relationship link existing between the at least first and second entity node coordinates.
Clause 19. The computer-implemented method as described in any preceding Clause, wherein for non-Euclidean spaces with spacetime manifolds, the link prediction function is based on the Fermi-Dirac function.
Clause 20. The computer-implemented method as described in Clause 19, wherein the link prediction function is based on a Triple Fermi-Dirac function comprising:

[symbol]

_{(τ}_{₁}_{,τ}_{₂}_{,α,r,k)}(p,q):=k(F₁F₂F₃)^{1/3},
where k>0 is a tunable scaling factor and

F₁:=F_{(τ}_{₁}_{,r,1)}(s²),

F₂:=F_{(τ}_{₂}_{,0,1)}(−Δt),

F₃:=F_{(τ}_{₂}_{,0,Δ)}(Δt),
are| three FD distribution terms. s² is the squared geodesic distance between p and q, Δt≡t_{q}−tₚ the difference in the time coordinates, and τ₁ τ₂, r and α the parameters from

$${F}_{( τ , r , α )} ( x ) := \frac{1}{{e}^{( α x - r ) / τ} + 1} ,$$

with x∈ [symbol] and parameters τ, r≥0, and 0≤α≤1, is used to represent the probability of undirected graph edges as a function of node embedding distances.
   Clause 21. The computer-implemented method as described in any preceding Clause, wherein the causal loss function includes the link prediction function.
   Clause 22. The computer-implemented method as described in Clauses 20 or 21, wherein the causal loss function comprises a cross entropy loss function combined with the link prediction function.
   Clause 23. The computer-implemented method as described in any preceding Clause, wherein the cross entropy loss function comprises a Multinomial Log Loss function or other Log Loss function using the link prediction function as the probability for the Multinomial Log Loss function or other Log Loss function.
   Clause 24. The computer-implemented method as described in any preceding Clause, wherein the causal loss function is used to conduct link predictions from the graph embedding that capture the directionality of relationships between nodes in the graph.
   Clause 25. An apparatus for generating an embedding a graph, wherein the graph comprises a plurality of nodes and each node includes an edge, connection, or link to another one or more of the nodes, the apparatus comprising a processor coupled to a communication interface, wherein: the communication interface is configured to receiving data representative of at least a portion of the graph; the processor is configured to: transform the nodes of the graph into a non-Euclidean geometry; and iteratively updating an embedding model based the transformed nodes in the non-Euclidean geometry based on a causal loss function associated with the non-Euclidean geometry, wherein the causal loss function includes a link prediction function.
   Clause 26. The apparatus as described in Clause 25, wherein the communication interface is configured to output the graph embeddings.
   Clause 27. The apparatus as described in claim 25 or 26, wherein the apparatus is configured to implement the computer-implemented method according to any preceding Clause.
   Clause 28. An embedding model obtained from a computer-implemented method according to any one of Clauses 1 to 24.
   Clause 29. A graph embedding for a graph obtained from a computer-implemented method according to any one of Clauses 1 to 24.
   Clause 30. A ML model obtained from a training dataset based on a graph embedding according to Clause 29.
   Clause 31. A ML model obtained from a training dataset based on a graph embedding based on the computer-implemented method according to any one of Clauses 1 to 35.
   Clause 32. A tangible (or non-transitory) computer-readable medium comprising data or instruction code for generating an embedding of a graph, which, when executed on one or more processor(s), causes at least one of the one or more processor(s) to perform at least one of the steps of: receiving data representative of at least a portion of the graph; transform the nodes of the graph into a non-Euclidean geometry; and iteratively updating an embedding model based the transformed nodes in the non-Euclidean geometry based on a causal loss function associated with the non-Euclidean geometry, wherein the causal loss function includes a link prediction function.
   Clause 33. A computer-readable medium comprising program data or instruction code which, when executed on a processor, causes the processor to perform one or more steps of the computer-implemented method as described in any one of Clause 1 to 35.
   Clause 34. The computer-implemented method as described in any preceding clause, further comprising creating a manifold or cylindrical topology by wrapping the non-Euclidean space in one dimension into a circle to create a higher-dimensional cylinder.
   Clause 35. The computer-implemented method as described in any preceding clause, wherein the manifold or cylindrical topology is a Pseudo-Riemannian manifold.
   Clause 36. The computer-implemented method, apparatus, tangible (or non-transitory) computer-readable medium, or computer-readable medium of any preceding claims, wherein the nodes of the graph are separated in a pseudo-Riemannian spaces distinctively in relation to space and time parameters.
   Clause 37. The computer-implemented method, apparatus, tangible (or non-transitory) computer-readable medium, or computer-readable medium of any preceding claims, wherein the graph is embedded topologically in manifolds.
   Clause 38. The computer-implemented method, apparatus, tangible (or non-transitory) computer-readable medium, or computer-readable medium of any preceding claims, wherein the causal loss function or the link prediction function are configured to replace nodes of the graph based on time by varying rate of decay of the functions.
   Clause 39. The computer-implemented method, apparatus, tangible (or non-transitory) computer-readable medium, or computer-readable medium of any preceding claims, wherein the causal loss function or the link prediction function are configured to relax transitivity of nodes based on temporal decay of the functions.
   In the embodiment described above the server may comprise a single server or network of servers. In some examples the functionality of the server may be provided by a network of servers distributed across a geographical area, such as a worldwide distributed network of servers, and a user may be connected to an appropriate one of the network of servers based upon a user location.
   The above description discusses embodiments of the invention with reference to a single user for clarity. It will be understood that in practice the system may be shared by a plurality of users, and possibly by a very large number of users simultaneously.
   The embodiments described above are fully automatic. In some examples a user or operator of the system may manually instruct some steps of the method to be carried out.

Further examples, embodiments and/or modifications to the embodiments of the invention as described herein are described by one or more of the following numbered clauses.

In the described embodiments of the invention the system may be implemented as any form of a computing and/or electronic device. Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

Various functions described herein can be implemented in hardware, software, or any combination thereof. If implemented in software, the functions can be stored on or transmitted over as one or more instructions or code on a computer-readable medium. Computer-readable media may include, for example, computer-readable storage media. Computer-readable storage media may include volatile or non-volatile, removable or non-removable media implemented in any method or technology for storage of information such as computer readable instructions, data structures, program modules or other data. A computer-readable storage media can be any available storage media that may be accessed by a computer. By way of example, and not limitation, such computer-readable storage media may comprise RAM, ROM, EEPROM, flash memory or other memory devices, CD-ROM or other optical disc storage, magnetic disc storage or other magnetic storage devices, or any other medium that can be used to carry or store desired program code in the form of instructions or data structures and that can be accessed by a computer. Disc and disk, as used herein, include compact disc (CD), laser disc, optical disc, digital versatile disc (DVD), floppy disk, and blu-ray disc (BD). Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, DSL, or wireless technologies such as infrared, radio, and microwave are included in the definition of communication medium. Combinations of the above should also be included within the scope of computer-readable media.

Alternatively, or in addition, the functionality described herein can be performed, at least in part, by one or more hardware logic components. For example, and without limitation, hardware logic components that can be used may include Field-programmable Gate Arrays (FPGAs), Program-specific Integrated Circuits (ASICs), Program-specific Standard Products (ASSPs), System-on-a-chip systems (SOCs). Complex Programmable Logic Devices (CPLDs), etc.

Although illustrated as a single system, it is to be understood that the computing device may be a distributed system. Thus, for instance, several devices may be in communication by way of a network connection and may collectively perform tasks described as being performed by the computing device.

Although illustrated as a local device it will be appreciated that the computing device may be located remotely and accessed via a network or other communication link (for example using a communication interface).

The term ‘computer’ is used herein to refer to any device with processing capability such that it can execute instructions. Those skilled in the art will realise that such processing capabilities are incorporated into many different devices and therefore the term ‘computer’ includes PCs, servers, mobile telephones, personal digital assistants and many other devices.

Those skilled in the art will realise that storage devices utilised to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realise that by utilising conventional techniques known to those skilled in the art that all, or a portion of the software instructions may be carried out by a dedicated circuit, such as a DSP, programmable logic array, or the like.

It will be understood that the benefits and advantages described above may relate to one embodiment or may relate to several embodiments. The embodiments are not limited to those that solve any or all of the stated problems or those that have any or all of the stated benefits and advantages. Variants should be considered to be included into the scope of the invention.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” is intended to mean “serving as an illustration or example of something”.

Further, to the extent that the term “includes” is used in either the detailed description or the claims, such term is intended to be inclusive in a manner similar to the term “comprising” as “comprising” is interpreted when employed as a transitional word in a claim.

The figures illustrate examples of the methods. While the methods are shown and described as being a series of acts that are performed in a particular sequence, it is to be understood and appreciated that the methods are not limited by the order of the sequence. For example, some acts can occur in a different order than what is described herein. In addition, an act can occur concurrently with another act. Further, in some instances, not all acts may be required to implement a method described herein.

Moreover, the acts described herein may comprise computer-executable instructions that can be implemented by one or more processors and/or stored on a computer-readable medium or media. The computer-executable instructions can include routines, sub-routines, programs, threads of execution, and/or the like. Still further, results of acts of the methods can be stored in a computer-readable medium, displayed on a display device, and/or the like.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

For purpose of sufficient disclosure, incorporated by its entirety each of the following references: Battaglia, P. W., Hamrick, J. B., Bapst, V., Sanchez-Gonzalez, A., Zambaldi, V., Malinowski, M., Tacchetti, A., Raposo, D., Santoro, A., Faulkner, R., Gulcehre, C., Song, F., Ballard, A., Gilmer, J., Dahl, G., Vaswani, A., Allen, K., Nash, C., Langston, V., Dyer, C., Heess, N., Wierstra, D., Kohli, P., Botvinick, M., Vinyals, O., Li, Y., and Pascanu, R. Relational inductive biases, deep learning, and graph networks. arXiv, 2018. Bombelli, L., Lee, J., Meyer, D., and Sorkin, R. D. Space-time as a causal set. Physical review letters, 59(5):521, 1987. Bonnabel, S. Stochastic gradient descent on Riemannian manifolds. IEEE Transactions on Automatic Control, 58(9):2217-2229, 2013. Bouchard, G., Singh, S., and Trouillon, T. On Approximate Reasoning Capabilities of Low-Rank Vector Spaces. AAAI spring symposia, 2015. Bradbury, J., Frostig, R., Hawkins, P., Johnson, M. J., Leary, C., Maclaurin, D., Necula, G., Paszke, A., VanderPlas, J., Wanderman-Milne, S., and Zhang, Q. JAX: composable transformations of Python+NumPy programs, 2018. URL http://github.com/google/jax. Clough, J. R. and Evans, T. S. Embedding graphs in Lorentzian spacetime. PLOS ONE, 12(11): e0187301, 2017. Ganea, O., Becigneul, G., and Hofmann, T. Hyperbolic entailment cones for learning hierarchical embeddings. In Dy, J. and Krause, A. (eds.), Proceedings of the 35th International Conference on Machine Learning, pp. 1646-1655, Stockholmsmässan, Stockholm Sweden, 2018. Gao, T., Lim, L.-H., and Ye, K. Semi-Riemannian Manifold Optimization. arXiv, 2018. Grover, A. and Leskovec, J. Node2vec: Scalable feature learning for networks. In Proceedings of the 22nd ACM SIGKDD International Conference on Knowledge Discovery and Data Mining, pp. 855-864, 2016. Isham, C. J. Modern Differential Geometry for Physicists. 1999. ISSN 1793-1436. Ispolatov, I., Krapivsky, P. L., and Yuryev, A. Duplication-divergence model of protein interaction network. Phys. Rev. E, 71:061911, June 2005. Krioukov, D., Papadopoulos, F., Kitsak, M., Vandat, A., and Boguñá, M. Hyperbolic geometry of complex networks. Phys. Rev. E, 82:036106, September 2010. Law, M. T. and Stam, J. Ultrahyperbolic representation learning. In Larochelle, H., Ranzato, M., Hadsell, R., Balcan, M., and Lin, H. (eds.), Advances in Neural Information Processing Systems 33, 2020. Marbach, D., Costello, J. C., Küffner, R., Vega, N. M., Prill, R. J., Camacho, D. M., Allison, K. R., Aderhold, A., Allison, K. R., Bonneau, R., Camacho, D. M., Chen, Y., Collins, J. J., Cordero, F., Costello, J. C., Crane, M., Dondelinger, F., Drton, M., Esposito, R., Foygel, R., Fuente, A. d. I., Gertheiss, J., Geurts, P., Greenfield, A., Grzegorczyk, M., Haury, A.-C., Holmes, B., Hothorn, T., Husmeier, D., Huynh-Thu, V. A., Irrthum, A., Kellis, M., Karlebach, G., Küffner, R., Lèbre, S., Leo, V. D., Madar, A., Mani, S., Marbach, D., Mordelet, F., Ostrer, H., Ouyang, Z., Pandya, R., Petri, T., Pinna, A., Poultney, C. S., Prill, R. J., Rezny, S., Ruskin, H. J., Saeys, Y., Shamir, R., Sïrbu, A., Song, M., Soranzo, N., Statnikov, A., Stolovitzky, G., Vega, N., Vera-Licona, P., Vert, J.-P., Visconti, A., Wang, H., Wehenkel, L., Windhager, L., Zhang, Y., Zimmer, R., Kellis, M., Collins, J. J., and Stolovitzky, G. Wisdom of crowds for robust gene network inference. Nature Methods, 9(8):796-804, 2012. ISSN 1548-7091. Nickel, M. and Kiela, D. Poincaré embeddings for learning hierarchical representations. In Guyon, I., Luxburg, U. V., Bengio, S., Wallach, H., Fergus, R., Vishwanathan, S., and Garnett, R. (eds.), Advances in Neural Information Processing Systems 30, pp. 6338-6347, 2017. Nickel, M. and Kiela, D. Learning continuous hierarchies in the Lorentz model of hyperbolic geometry. In Dy, J. and Krause, A. (eds.), Proceedings of the 35th International Conference on Machine Learning, volume 80, pp. 3779-3788, 2018. Nickel, M., Tresp, V., and Kriegel, H.-P. A three-way model for collective learning on multi-relational data. In Getoor, L. and Scheffer, T. (eds.), Proceedings of the 28th International Conference on Machine Learning, pp. 809-816, 2011. Perozzi, B., Al-Rfou, R., and Skiena, S. Deepwalk: Online learning of social representations. In Proceedings of the 20th ACM SIGKDD International Conference on Knowledge Discovery and Data Mining, pp. 701-710, 2014. Robbin, J. W. and Salamon, D. A. Introduction to differential geometry, March 2013. Sala, F., De Sa, C., Gu, A., and Re, C. Representation tradeoffs for hyperbolic embeddings. In Dy, J. and Krause, A. (eds.), Proceedings of the 35th International Conference on Machine Learning, volume 80 of Proceedings of Machine Learning Research, pp. 4460-4469, 2018. Sun, K., Wang, J., Kalousis, A., and Marchand-Maillet, S. Space-time local embeddings. In Cortes, C., Lawrence, N., Lee, D., Sugiyama, M., and Garnett, R. (eds.), Advances in Neural Information Processing Systems 28, pp. 100-108, 2015. Suzuki, R., Takahama, R., and Onoda, S. Hyperbolic disk embeddings for directed acyclic graphs. In Chaudhuri, K. and Salakhutdinov, R. (eds.), Proceedings of the 36th International Conference on Machine Learning, pp. 6066-6075, 2019. Trouillon, T., Welbl, J., Riedel, S., Gaussier, E., and Bouchard, G. Complex embeddings for simple link prediction. In Balcan, M. F. and Weinberger, K. Q. (eds.), Proceedings of the 33rd International Conference on Machine Learning, pp. 2071-2080, 2016. Vendrov, I., Kiros, R., Fidler, S., and Urtasun, R. Order-embeddings of images and language. In Bengio, Y. and LeCun, Y. (eds.), 4th International Conference on Learning Representations, 2016. Vilnis, L. and McCallum, A. Word representations via Gaussian embedding. In Bengio, Y. and LeCun, Y. (eds.), 3rd International Conference on Learning Representations, 2015. Visser, M. How to Wick rotate generic curved spacetime. arXiv, 2017.

1. A computer-implemented method of generating an embedding of a graph, wherein the graph comprises nodes and each node includes a connection to another one or more of the nodes, the computer-implemented method comprising:
receiving data representative of at least a portion of the graph;
transforming the nodes of the graph into a non-Euclidean geometry; and
iteratively updating an embedding model based the transformed nodes in the non-Euclidean geometry based on a causal loss function and a link prediction function associated with the non-Euclidean geometry.

2. The computer-implemented method as claimed in claim 1, wherein:
transforming the nodes of the graph further comprises transforming the nodes of the graph into coordinates of the non-Euclidean geometry; and
wherein the embedding model is based on a non-Euclidean stochastic gradient descent algorithm operating on the node coordinates using the causal loss function.

3. The computer-implemented method as claimed in claim 1, wherein updating the embedding model further includes updating the node coordinates by minimising the causal loss function based on at least the embeddings and the link prediction function.

4. The computer-implemented method as claimed in claim 1, further comprising iteratively updating the embedding model until the embedding model is determined to be trained; a maximum number of iterations has been reached, and/or or until an average loss threshold has been met for all node coordinates; and outputting data representative of the graph embedding once trained.

5. The computer-implemented method as claimed in claim 1, wherein the graph is a directed graph.

6. The computer-implemented method as claimed in claim 1, wherein the graph is a cyclic or acyclic directed graph.

7. The computer-implemented method as claimed in claim 1, wherein the non-Euclidean geometry is one of:
a pseudo-Riemannian geometry or space;
a Minkowski geometry or space;
an anti-de Sitter geometry or space, or a de-Sitter geometry or space; or
a hyperbolic geometry or space.

8. The computer-implemented method as claimed in claim 1, wherein the graph is an entity-entity graph comprising a plurality of entity nodes and a plurality of connections, wherein each entity node connects to another entity node via a connection, each connection representing a relationship between said each entity node and the connected said other entity node.

9. The computer-implemented method as claimed in claim 1, wherein an entity node in the entity-entity graph represents any entity from the group of: gene; disease; compound/drug; protein; biological entity; pathway; biological process; cell-line; cell-type; symptom; clinical trials; any other biomedical concept; or any other entity with at least an entity-entity relationship to another entity in the entity-entity graph.

10. The computer-implemented method as claimed in claim 1, further comprising outputting the embeddings of the graph from the trained entity model for use in downstream process(es) including one or more from the group of: drug discovery; drug optimisation; and/or for any other ML model or training any other ML model for predicting or classifying in a drug discovery or optimisation process.

11. The computer-implemented method as claimed in claim 1, further comprising:
predicting link relationships between nodes or entity nodes in the embeddings of the graph based on inputting data representative of a first and second node into the link prediction function; and
receiving from the link prediction function an indication of a likelihood of a link relationship existing between said first and second node.

12. A computer-implemented method for link prediction in a graph further comprising:
generating a graph embedding according to claim 1; and
selecting at least a first and second node coordinate from the graph embedding; and
outputting a directed link prediction based on inputting the selected first and second node coordinate to the link prediction function, wherein the directed link prediction includes an indication of a likelihood of a link relationship existing between the first and second node coordinates.

13. The computer-implemented method as claimed in claim 1, wherein for non-Euclidean spaces with spacetime manifolds, the link prediction function is based on the Fermi-Dirac function.

14. The computer-implemented method as claimed in claim 13, wherein the link prediction function is based on a Triple Fermi-Dirac function comprising: [symbol]
_{(τ}_{₁}_{,τ}_{₂}_{,α,r,k)}(p,q):=k(F₁F₂F₃)^{1/3},
where k>0 is a tunable scaling factor and
F₁:=F_{(τ}_{₁}_{,r,1)}(s²)
F₂:=F_{(τ}_{₂}_{,0,1)}(−Δt)
F₃:=F_{(τ}_{₂}_{,0,Δ)}(Δt)
and three FD distribution terms, s² is the squared geodesic distance between p and q, Δt≡t_{q}−tₚ is the difference in time coordinates, and τ₁, τ₂, r, and α the parameters from
$${F}_{( τ , r , α )} ( x ) := \frac{1}{exp [ ( α x - r ) / τ ] + 1} ,$$
with x∈ [symbol] and parameters T, r≥0 and 0≤α≤1, is used to represent a probability of undirected graph edges as a function of node embedding distances.

15. The computer-implemented method as claimed in claim 1, wherein the causal loss function includes the link prediction function.

16. The computer-implemented method as claimed in claim 15, wherein the causal loss function comprises a cross entropy loss function combined with the link prediction function.

17. The computer-implemented method as claimed in claim 1, wherein the cross entropy loss function comprises a Multinomial Log Loss function or other Log Loss function using the link prediction function as a probability for the Multinomial Log Loss function or other Log Loss function.

18. The computer-implemented method as claimed in claim 1, wherein the causal loss function is used to conduct link predictions from the graph embedding that capture a directionality of relationships between nodes in the graph.

19. The computer-implemented method as claimed in claim 1, further comprising creating a manifold or cylindrical topology by wrapping a non-Euclidean space in one dimension into a circle to create a higher-dimensional cylinder.

20. The computer-implemented method as claimed in claim 19, wherein the manifold or cylindrical topology is a Pseudo-Riemannian manifold.

21. The computer-implemented method of claim 1, wherein the nodes of the graph are separated in pseudo-Riemannian spaces distinctively in relation to space and time parameters.

22. The computer-implemented method of claim 1, wherein the graph is embedded topologically in manifolds.

23. The computer-implemented method of claim 1, wherein the causal loss function or the link prediction function are configured to replace nodes of the graph based on time by varying rate of decay of the functions.

24. The computer-implemented method of claim 1, wherein the causal loss function or the link prediction function are configured to relax transitivity of nodes based on temporal decay of the functions.

25. A computer-readable medium comprising program data or instruction code which, when executed on a processor, causes the processor to perform one or more steps of the computer-implemented method as claimed in claim 1.
